(19) United States
(12) Patent Application Publication
(10) Pub. No.: US 2026/0267687 A1
(43) Pub. Date: Sep. 10, 2026

(54) SEARCHING LOOP TRANSFORMATION SCHEDULE FOR DEEP LEARNING MODEL

(71) Applicant: Intel Corporation, Santa Clara, CA (US)

(72) Inventors: Hongbo Rong, San Jose, CA (US); Mingzhe Zhang, Beijing (CN); Evangelos Georganas, SAN JOSE, CA (US); Alexander Heinecke, San Jose, CA (US); Lorenzo Chelini, Zurich (CH); Renato Golin, Cambridge (GB); Kavitha Madhu, Bangalore (IN); Xin Chen, Los Altos, CA (US); Sasikanth Avancha, Kolar District (IN); Niranjan Hasabnis, San Jose, CA (US); Hans Pabst, Wittenberg ST (DE)

(73) Assignee: Intel Corporation, Santa Clara, CA (US)

(21) Appl. No.: 19/167,705

(22) PCT Filed: Apr. 26, 2023
(86) PCT No.: PCT/CN2023/090866

§ 371 Date: Sep. 22, 2025

(51) Int. Cl. G06F 9/48

(52) U.S. Cl. CPC G06F 9/4881

(57) ABSTRACT

A compiler may identify tensor operations in a deep learning model. For each tensor operation, the compiler may generate schedules arranged in a hierarchical structure. The compiler may select one or more schedules from the lowest level of the hierarchical structure by inputting the schedules at the lowest level and optionally other data into a trained model. The trained model may output a selection of one or more schedules. After selecting schedules for the tensor operations, the compiler may generate a graph including edges representing connections between the schedules. Each edge connects a schedule for a producing tensor operation to a schedule for a consuming tensor operation. The compiler may determine a weight for each edge and select a path based on the weights of the edges. The schedules along the path constitute a combined schedule to be used to transform loops of the deep learning model. WO

### TECHNICAL FIELD

This disclosure relates generally to neural networks, and more specifically, to generating loop transformation schedules for deep learning models, such as deep neural networks (DNNs).

### BACKGROUND

DNNs are used extensively for a variety of artificial intelligence applications ranging from computer vision to speech recognition and natural language processing due to their ability to achieve high accuracy. However, the high accuracy comes at the expense of significant energy cost. DNNs have extremely high computing demands as each inference can require hundreds of millions of tensor operations, such as convolution, pooling operation, elementwise operations, and other types of tensor operations. Therefore, techniques to improve energy efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2 illustrates a tensor computation environment, in accordance with various embodiments.

FIG. 3 is a block diagram of deep learning compiler, in accordance with various embodiments.

FIG. 4 is a block diagram of a schedule engine, in accordance with various embodiments.

FIG. 5 is a block diagram of a schedule generator, in accordance with various embodiments.

FIG. 6 is a block diagram of a schedule selecting module, in accordance with various embodiments.

FIG. 7 illustrates an example graph for searching a schedule for a deep learning model, in accordance with various embodiments.

FIG. 8 illustrates an example schedule tree of an intermediate representation (IR), in accordance with various embodiments.

FIG. 9 is a flowchart showing a method of generating a schedule for a deep learning model, in accordance with various embodiments.

FIG. 10 illustrates a deep learning environment, in accordance with various embodiments.

FIG. 11 is a block diagram of an example deep learning system, in accordance with various embodiments.

FIG. 12 is a block diagram of an example computing device, in accordance with various embodiments.

### DETAILED DESCRIPTION

### Overview

Deep learning models are widely used in the domains of computer vision, speech recognition, image, and video processing mainly due to their ability to achieve beyond human-level accuracy. Tensor computation is a key to deep learning. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. A deep learning model may include a plurality of tensor operations. A tensor operation may process an input tensor to compute an output tensor. The input tensor or output tensor may include a plurality of data elements arranged in a data structure. Examples of tensor operations include convolutions (e.g., standard convolution, depthwise convolution, pointwise convolution, group convolution, etc.), deconvolution, pooling operations, elementwise operations (e.g., elementwise addition, elementwise multiplication, etc.), linear operations, nonlinear operations, other types of tensor operations, or some combination thereof.

After a deep learning model is trained, it is to be deployed on specific hardware (e.g., a computing device), where it is translated by a compiler from a high-level specification into low-level machine instructions or library calls. The deployment phase can be time consuming. Sometimes, it can take several hours to several days. During the deployment phase, the compiler can optimize tensor operations to generate low-level code with better performance. The optimization may be critical, as the deep learning model might be deployed to run endlessly on the hardware.

Tensor operations are at the heart of deep learning models. Many tensor operations include memory and ALU (arithmetic logic unit) operations enclosed in loop nests and can take most of the execution time of the models. Therefore, compilers usually focus on optimizing tensor operations in deep learning models. A critical problem is how to identify an efficient schedule of loop transformations that can minimize data movement across a memory hierarchy (e.g., a memory hierarchy including vector registers, multi-level caches, main memory, etc.) and maximizes parallelism. A challenge solving the problem is the enormous size of the schedule space. The size of the schedule space depends on the number of loops pertaining to a specific tensor operation, tiling strategies (e.g., number of tilings applied to the loops, factors of tiling, and order of the tiled loops), parallelization strategies, and so on.

A solution to this problem is polyhedral compilation and analytical models. Polyhedral compilers formulate optimization models such as ILP (integer linear programming) models to solve the problem. Analytical models of caches are usually built for important computations like matrix multiply and convolution to guide the selection of loop order and loop extents for the best cache performance. However, solving ILP problems can be time consuming. While coarse-grain analytical modeling can be effective, fine-grain accurate modeling of performance is hard in practice due to modern architecture features like out-of-order execution and hardware prefetching. For example, a currently available analytical model solves non-linear optimization problems at coarse-grain level, without modeling associativity of caches.

Another solution is Autotuning. Autotuning can search the parameter space (in various ways like hill combing, high variance sampling, etc.), measure the results, and identify the best values of the parameters. For example, a TVM (tensor virtual machine) compiler accepts a tiled loop structure and a specification of a search space like permutations of a subset of loops, iterates through tiled loop configurations, generates and runs code on hardware, and measures performance. However, autotuning can be very time consuming. It can take at least hours, and often days.

Yet another solution is empirical search. The schedule space can be searched by, e.g., a tree where every node is a loop transform, and a deep learning model can be queried for predicted performance. Different search algorithms like beam search or Monte Carlo tree search can be applied. Various program features, including tensor references, operation counts, load/store bytes, etc. can be used to build up a deep learning model. However, the advantage of deep learning models is to predict performance of schedules quickly, saving time of running the schedules on real hardware. However, how to search the enormous schedule space remains a challenge: to avoid missing best schedules in searching a tree, beam search requires the prediction of deep learning models to be extremely accurate, and Monte Carlo tree search necessarily requires a large amount of stochastic sampling of the schedule space. Therefore, improved technologies for searching loop transformation schedules are needed.

Embodiments of the present disclosure may improve on at least some of the challenges and issues described above by using a machine learning model to search optimal schedules for tensor operations in a deep learning model and solving a dynamic programming problem to identify an optimal schedule for the deep learning model based on dataflow between the tensor operations. The present disclosure may be applied to any compiler for deploying deep learning models, including MLIR (Multi-Level Intermediate Representation) compilers, which can generate a transformation MLIR sequence to implement the optimal schedule and simplify the compiler construction by decoupling scheduling from its implementation.

The present disclosure provides a tensor computing environment in which source code for a tensor operation in a deep learning model can be converted to an IR. An IR may be a data structure that specifies the corresponding tensor operation. An IR may include a loop nest. The loop nest includes a plurality of loops. A loop indicates a tensor operation to be repeatedly executed. The number of times that tensor operation is to be repeatedly executed is the extent of the loop, which is also referred to as loop extent or extent. The tensor computing environment includes a deep learning compiler that can use a trained model to search schedules (aka “loop transformation schedules”) that are optimal for transforming loops in the IRs of tensor operations in the deep learning models. A schedule may specify one or more loop transformations for the IR of a tensor operation. The one or more loop transformations may be in a sequence.

In various embodiments of the present disclosure, the deep learning compiler may identify tensor operations in a deep learning model. In some embodiments, the deep learning compiler identifies key tensor operations in the deep learning model. For each tensor operation, the deep learning compiler may generate a schedule tree including schedules arranged in a hierarchical structure. The deep learning compiler may select one or more schedules from the lowest level of the hierarchical structure, e.g., by using a trained model. The deep learning compiler may input the schedules at the lowest level and other data (e.g., one or more parameters of a computing device executing the deep learning model, one or more parameters of the tensor operation, etc.) into the trained model. The trained model may output ranking of the schedules. The schedules may be ranked based on predicted performance of the computing device executing the tensor operation (or the deep learning model) if the IR of the tensor operation is transformed based on each respective schedule. The deep learning compiler may select one or more schedules that are ranked higher (i.e., with better predicted performance) than other schedules at the lowest level.

After the deep learning compiler selects schedules for two or more tensor operations in the deep learning model, the deep learning compiler may generate a combined schedule for the deep learning model. The combined schedule includes a schedule for each respective tensor operation. To find the schedule for each respective tensor operation, the deep learning compiler may generate a graph including a plurality of levels. Each level corresponds to a different tensor operation and includes the one or more schedules selected for the tensor operation. The output data of a tensor operation (“producing tensor operation”) corresponding to a level may be used as input data of a second tensor operation (“consuming tensor operation”) corresponding to the immediately subsequently level. The deep learning compiler may build edges between every two adjacent levels, where each respective schedule in one of the levels is connected to each respective schedule in the other level through an edge. The graph may include a plurality of paths, each path is from a schedule in the first level to a schedule in the last level. In an example where a first level includes three schedules and a second level includes two schedules, the deep learning compiler builds six edges.

The deep learning compiler may determine a weight for each respective edge connecting a first schedule for the producing tensor operation to a second schedule for the consuming tensor operation. The weight may be a data transformation score indicating computing resources required for transforming an output tensor of the producing tensor operation optimized with the first schedule to an input tensor of the consuming tensor operation optimized with the second schedule. The deep learning compiler may further determine a total data transformation score for each respective path. The deep learning compiler may select a path having the lowest data transformation score. The schedules along the selected path constitute the combined schedule for the deep learning model. The deep learning compiler may transform IRs of the tensor operations in the deep learning model based on the combined schedule.

Compared with currently available compilers, the deep learning compiler in the present disclosure can search optimal schedule for a deep learning model with less computing resources. Also, the deep learning compiler can shorten the deployment phase of the deep learning model, e.g., from hours or days to minutes. In some applications, the deep learning compiler in the present disclosure can shorten the deployment phase with up to three orders of magnitudes faster than currently available compilers.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, modules, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN

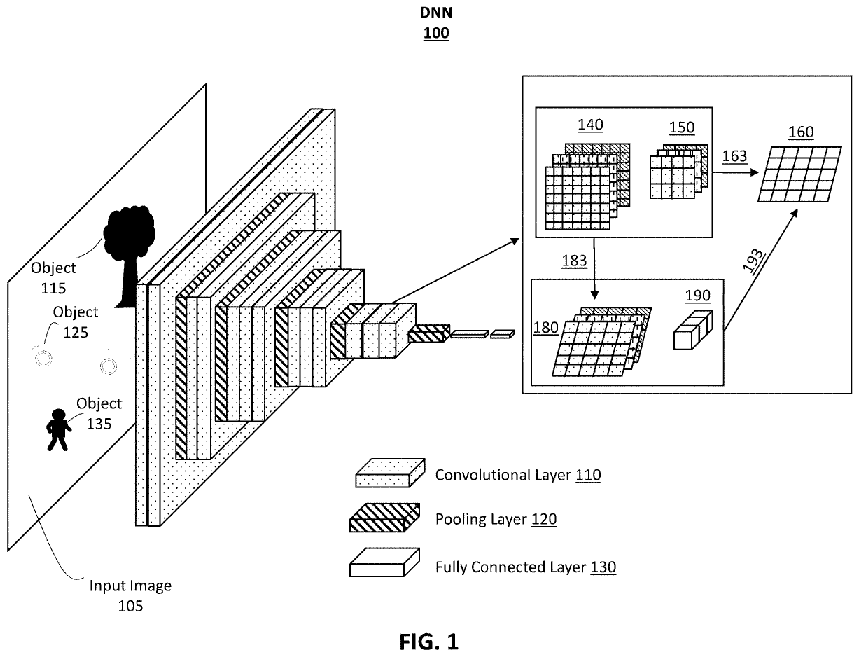

FIG. 1 illustrates an example DNN 100, in accordance with various embodiments. For the purpose of illustration, the DNN 100 in FIG. 1 is a convolutional neural network (CNN). In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as input feature map (IFM) 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as output feature map (OFM) 160). The OFM 160 is represented by a 5×≡2D matrix. The 5×≡2D matrix includes 5 output elements (also referred to as output points) in each row and 5 output elements in each column. For the purpose of illustration, the standard convolution includes one filter in the embodiments of FIG. 1. In embodiments where there are multiple filters, the standard convolution may produce multiple output channels in the OFM 160 The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is rectified linear unit (ReLU). ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layer 110 performs a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between 2 convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be implemented as convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, softmax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

### Example Tensor Computation Environment

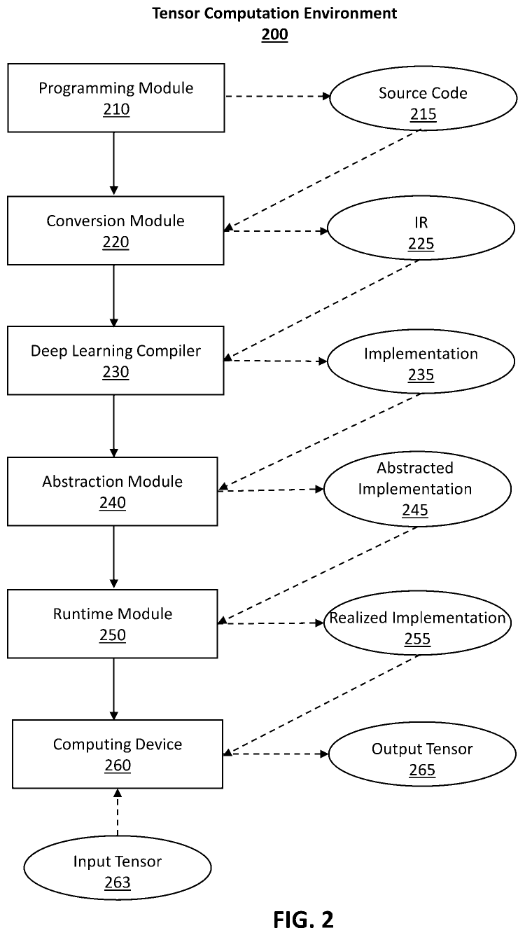

FIG. 2 illustrates a tensor computation environment 200, in accordance with various embodiments. The tensor computation environment 200 provides an environment where one or more tensor operations in a deep learning model, such as the DNN 100 in FIG. 1, can be performed. Tensor operations may include convolution, pooling operation, elementwise operation (e.g., elementwise addition, elementwise multiplication, etc.), loading, reducing, other types of tensor operations by the deep learning model, or some combination thereof. As shown in FIG. 2, the tensor computation environment 200 includes a programming module 210, a conversion module 220, a deep learning compiler 230, an abstraction module 240, a runtime module 250, and a computing device 260. The programming module 210, a conversion module 220, a deep learning compiler 230, and an abstraction module 240 may be at least partially implemented in software. The computing device 260 may be at least partially implemented in hardware. In other embodiments, alternative configurations, different or additional components may be included in the tensor computation environment 200. Further, functionality attributed to a component of the tensor computation environment 200 may be accomplished by a different component included in the tensor computation environment 200 or by a different system.

The programming module 210 facilitates generation of source code 215. The source code 215 is a set of computer program instructions in a human-readable form. The computer instructions are to be executed by the computing device 260 (e.g., one or more processing units in the computing device 260) to perform tensor computation. In some embodiments, the source code 215 is written in a high-level programming language, such as C, C++, Java, Python, and so on. The source code 215 cannot be executed by the processing device directly and needs to be converted to machine code that is executable by the processing device.

In an embodiment, the programming module 210 provides a programming environment in which users can write computer program instructions in one or more programming languages. The programming languages supported by the programming module 210 may be a human-readable programming language, such as C, C++, Java, Python, and so on. In another embodiment, the programming module 210 may receive the source code 215 from another system or device. For example, the programming module 210 may retrieve the source code 215 from a library of a deep learning framework. As another example, the programming module 210 may retrieve the source code 215 from a memory associated with the DNN. As yet another example, the programming module 210 may retrieve the source code 215 from a computer device in communication with the programming module 210.

The conversion module 220 receives the source code 215 and converts the source code 215 to an IR 225. The IR 225 is a data structure that represents the source code 215. The IR 225 includes a loop nest indicating one or more tensor operations to be executed by the computing device 260. The loop nest includes a sequence of loops where a loop is inside of one or more other loops that are subsequent to the loop in the sequence. The first loop in the sequence may be the inner most loop, and the last loop in the sequence may be the outer most loop. A loop may include a sequence of programming instructions that is specified once but may be carried out multiple times in succession. A loop may indicate a tensor operation to be repeatedly executed by the computing device 260. The number of times that the tensor operation is to be executed is the extent of the loop. A loop having an extent equal to 1 is a unity loop. The tensor operations may be for tensors of same dimensions.

The IR 225 may include information indicating attributes of the loop nest. The attributes of the loop nest may include the tensor operation to be executed, tensor references, loop extents, other attributes of the loop nest, or some combination thereof. The tensor references may include tensor rank (i.e., the number of dimension(s) of the tensor, e.g., 1, 2, 3, etc.), tensor shape (i.e., the number of elements in each dimension of the tensor), tensor length (the total number of elements in the tensor), other tensor references, or some combination thereof. The IR 225 may include code indicating other attributes of the loop nest.

The IR 225 may be subject to further processing, such as loop transformation. The IR 225 may have a data structure form, such as an in-memory data structure, special tuple-based code, stack-based code, or other forms. Compared with the source code 215, the IR 225 may have a form that is more suitable for code-improving transformations before being used to generate machine code for a target device, e.g., the processing device. The conversion module 220 may be part of a programming framework, such as Keras, TensorFlow, OpenVino, and so on.

The deep learning compiler 230 receives IRs (e.g., including the IR 225) of tensor operations in the deep learning model. The deep learning compiler 230 may identify some of or all the tensor operations (e.g., key tensor operations), search optimal schedules for the identified tensor operations, and search an optimal schedule for the deep learning model, which can be used to optimize the IRs of the deep learning model. A schedule may specify a sequence of loop transformations. The deep learning compiler 230 may perform various types of loop transformation, such as loop permutation, index rewriting, loop unrolling, loop splitting, loop tiling, loop padding, other types of loop transformation, or some combination thereof.

Loop permutation can change the order of loops in a loop nest. Index rewriting can change the way the loop indexes are expressed. Loop unrolling can create one or more copies of a loop body and modifies the loop indexes appropriately. Loop splitting can divide a loop with multiple operations to multiple separate loops, each operation corresponds to a different one of the separate loops. Loop fusion can fuse multiple loops into one loop, and the new loop incorporates the operations of the multiple loops. Loop tiling can split a loop into a nest of loops, with each inner loop working on a small block of the data of the original loop. Loop padding can add data elements to an array to change how the array maps into the memory system structure. Loop transformation can increase execution speed and reduce overheads associated with loops. Optimization through loop transformation can improve cache performance and make effective use of parallel processing capabilities.

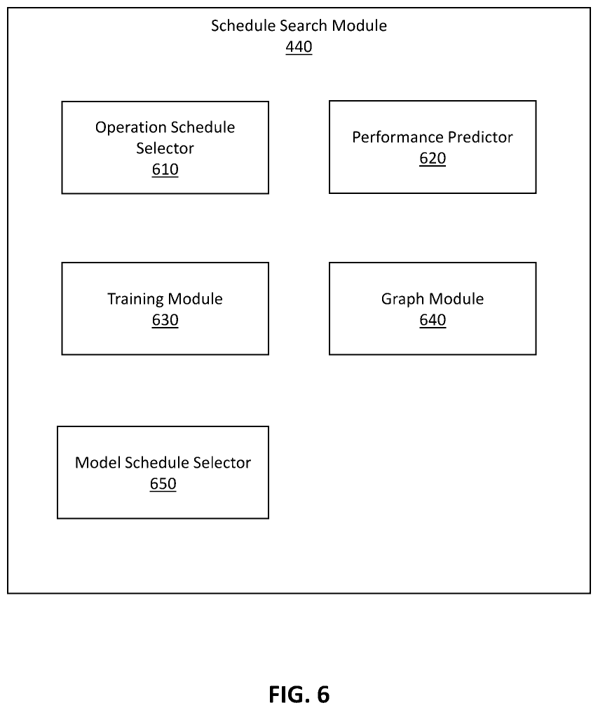

In some embodiments, the deep learning compiler 230 generates a schedule tree for the loop nest of an identified tensor operation. The schedule tree includes schedules arranged based on their hierarchies. The schedule tree includes a root, which has the highest hierarchy. The root may be the IR 225. The root can be the parent of one or more nodes, which have the second highest hierarchy. A node in the second level can be a parent of one or more nodes in the third level. The schedule tree may have two or more levels. Every node in the schedule tree is a schedule. The lowest hierarchy level of the schedule tree may include a plurality of schedules. More details regarding schedule tree are described below in conjunction with FIG. 6.

In some embodiments, the deep learning compiler 230 maintains, e.g., through caching, a database including schedule trees that have been generated or used for previous IRs. Deep learning is an important application domain of the deep learning compiler 230. Many deep learning models include similar or even same layers that perform same tensor operations. The deep learning compiler 230 can run a similarity search in the database to determine whether the IR is the same as or similar to any of the previous IRs. In embodiments where the deep learning compiler 230 finds a matching (i.e., same or similar) IR in the database, the deep learning compiler 230 can use the already-created schedule trees of the matching IR to generate the schedule tree of the IR, which can be more time and resource efficient than generating the schedule tree from scratch.

After the deep learning compiler 230 generates the schedule tree, the deep learning compiler 230 selects, from schedules at the lowest hierarchy level of the schedule tree (“lowest hierarchy schedules”), one or more schedules that can trigger predicted, optimal performance of the computing device 260 in the execution of the tensor operation. The deep learning compiler 230 may use a trained model to predict performance of the computing device 260.

The deep learning compiler 230 may input the lowest hierarchy schedules and other data (e.g., one or more parameters of a computing device executing the deep learning model, one or more parameters of the tensor operation, etc.) into a trained model. The trained model may output a selection of one or more schedules. In some embodiments, the trained model may output a ranking of the lowest hierarchy schedules and the one or more schedules may be ranked higher than the rest of the lowest hierarchy schedules. The selected one or more schedules are considered optimal schedule(s) for the tensor operation. A selected schedule may adopt its ancestor(s) (e.g., parent, grandparent, great grandparent, etc.) in the schedule tree. The selected schedule and its ancestor(s) may constitute a sequence of schedules that specifies a sequence of loop transformations that may be used to transform the loop nest.

After the deep learning compiler 230 selects optimal schedules for the identified tensor operations, the deep learning compiler may generate an optimal schedule for the deep learning model, which may be referred to as a combined schedule. To generate the combined schedule, the compiler may generate a graph that includes edges representing connections between the schedules of the identified tensor operations. Each edge connects a schedule for a producing tensor operation to a schedule for a consuming tensor operation. The compiler may determine a weight for each edge and select a path having the lowest total weight. The schedules along the selected path constitute a combined schedule that can be used to transform IRs of the tensor operations in the deep learning model.

After the deep learning compiler 230 selects the combined schedule, the deep learning compiler 230 implements the combined schedule to transform the loop nests of the deep learning model. The deep learning compiler 230 may use a schedule in the combined schedule to transform the loop nest of the tensor operation corresponding to the schedule. For instance, the deep learning compiler 230 can optimize the IR 225 by transforming one or more loops in the loop nest of the IR 225 based on a schedule in the combined schedule that corresponds to the tensor operation of the IR 225.

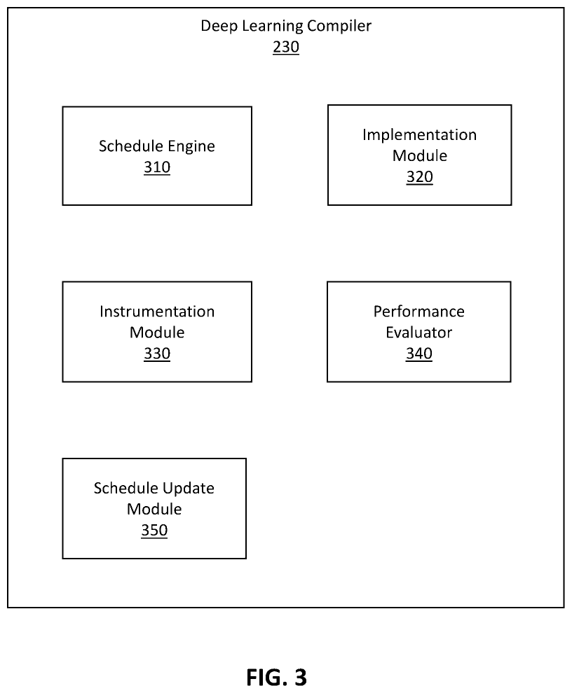

The result of the transformation is an implementation 235. In some embodiments, the deep learning compiler 230 also instruments the implementations 235 so that when the implementation 235 runs on the computing device 260, information indicating a performance of the computing device 260 can be generated and provide to the deep learning compiler 230, e.g., from the runtime module 250. The deep learning compiler 230 can use the performance information to determine a runtime performance score that indicates an evaluation of the runtime performance of the computing device 260 in the execution of the tensor operations with the implementation 235. The selected schedule and the runtime performance score can be used to further train the trained model. As the deep learning compiler 230 continuously selects schedules and determines runtime performance scores for the schedules, the deep learning compiler 230 can continuously train the trained model. More details regarding the deep learning compiler 230 are described below in conjunction with FIGS. 3-5.

The abstraction module 240 is between the deep learning compiler 230 and the computing device 260. The abstraction module 240 allows the deep learning compiler 230 to interact with the computing device 260 at a general and abstract level, as opposed to a detailed hardware level. The abstraction module 240 may include a hardware abstraction layer. The abstraction module 240 converts the implementation 235 to an abstracted implementation 245. In some embodiments, the abstraction module 240 may replace one or more loops in the implementation 235 with microkernels in the abstracted implementation 245. For instance, the abstraction module 240 can replace one or more loops at the innermost level of the loop nest with microkernels. Loops at the innermost level may be loops corresponding to the memory of the highest hierarchy, such as registers of the computing device 260. The microkernels may be virtual instructions. The abstraction module 240 can hide differences in hardware of the computing device 260 so that the code does not need to be changed to run on processing devices with different hardware.

The runtime module 250 facilitates the execution of the tensor operations by the computing device 260 and provides an environment in which the abstract implementation 245 runs. Runtime refers to the period during which the computing device 260 executes the tensor operations. The runtime module 250 may address a number of issues related to the execution of the tensor operations by the computing device 260, e.g., management of memory, access of variables, interfacing with operating system, and so on. The runtime module 250 may realize the microkernels in the abstracted implementation 245 and generates realized implementation 255 that can be executed by the processing device 360. The realized implementation 255 may be machine code. In some embodiments, the runtime module 250 includes a library.

The computing device 260 executes, in accordance with the realized implementation 255, the tensor operations on an input tensor 263 and generates an output tensor 265. An example of the input tensor 263 is the IFM 140 in FIG. 1. An example of the output tensor 265 is the OFM 160 in FIG. 1. The computing device 260 may constitute one or more layers of a DNN, an example of which is the DNN 100 in FIG. 1. The computing device 260 includes hardware components that can execute tensor computation. In an embodiment, the computing device 260 includes a plurality of processing elements that can perform MAC operations, pooling operations, elementwise operations, other types of deep learning operations, or some combination thereof. The processing elements may be arranged in one or more tiles. Each tile may include an array of processing elements, in which the processing elements are arranged in rows and columns. The computing device 260 may also include one or more memories, such as registers, cache memories (e.g., L0 cache, L1 cache, L2 cache, etc.). Data used or generated by the computing device 260, such as input tensor 263 and the output tensor 265, may be stored in some or all of the memories. Even though FIG. 2 shows one processor, the tensor computation environment 200 may include multiple processors in other embodiments.

### Example Deep Learning Compiler

FIG. 3 is a block diagram of the deep learning compiler 230, in accordance with various embodiments. The deep learning compiler 230 includes a schedule engine 310, an implementation module 320, an instrumentation module 330, a performance evaluator 340, and a schedule update module 350. In other embodiments, alternative configurations, different or additional components may be included in the deep learning compiler 230. Further, functionality attributed to a component of the deep learning compiler 230 may be accomplished by a different component included in the deep learning compiler 230 or by a different system.

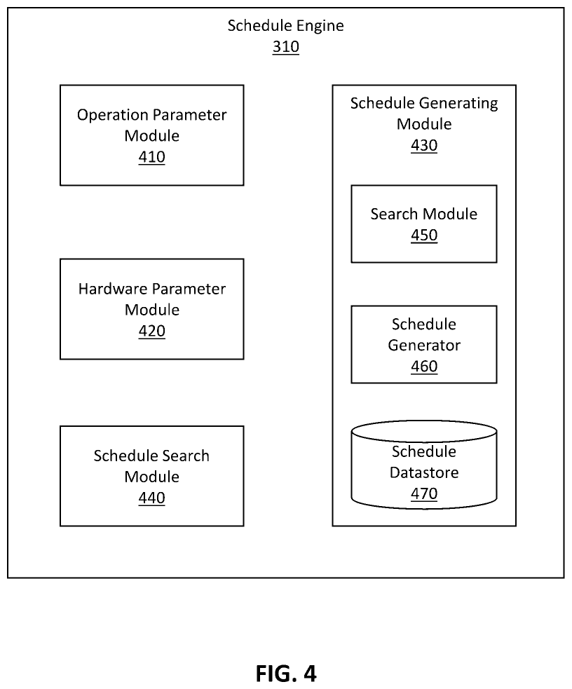

The schedule engine 310 generates optimal schedules for deep learning models. The schedule engine 310 may identify tensor operations in a deep learning model. For each tensor operation, the schedule engine 310 may generate a schedule tree including schedules arranged in a hierarchical structure. The schedule engine 310 may select one or more schedules from the lowest level of the hierarchical structure by inputting the schedules at the lowest level and other data (e.g., parameter(s) of a computing device executing the deep learning model, parameter(s) of the tensor operation, etc.) into a trained model. The trained model may output a selection of one or more schedules. After the schedule engine 310 selects schedules for the tensor operations, the schedule engine 310 may generate a graph that includes edges representing connections between the schedules. Each edge connects a schedule for a producing tensor operation to a schedule for a consuming tensor operation. The schedule engine 310 may determine a weight for each edge and select a path having the lowest total weight. The schedules along the selected path constitute a combined schedule that can be used to transform IRs of the tensor operations in the deep learning model. Certain aspects of the schedule engine 310 are described below in conjunction with FIG. 4.

The implementation module 320 transforms the loop nest in the IR in accordance with the schedule obtained by the schedule engine 310. The loop transformation can improve performance of the computing device 260 in executing the tensor operations. For instance, the loop transformation can increase execution speed of the computing device 260 so that the execution time is reduced. It can also reduce the overheads associated with the loops and make effective use of parallel processing capabilities. It also plays an important role in improving performance of memories, such as registers and cache memory. Through the transformation, the implementation module 320 generates an implementation, e.g., the implementation 235.

The instrumentation module 330 instruments the implementation generated by the implementation module 320 to facilitate generation of performance information. In some embodiments, the instrumentation module 330 adds one or more instructions in the implementation 235. The instructions, when executed by the computing device 260, cause information indicating performance of the computing device 260 in the execution of the tensor computation to be sent to the deep learning compiler 230, e.g., to the performance evaluator 340. The performance information may include information indicating the time that the computing device 260 took to execute the tensor computation, information indicating memory misses (e.g., cache misses), other information indicating the performance of the computing device 260, or some combination thereof. The performance information may be runtime performance information, which can be provided by the runtime module 250.

The performance evaluator 340 uses the performance information to evaluate performance of the computing device 260 in execution of tensor operations. The performance evaluator 340 may determine a runtime performance score indicating the runtime performance of the computing device 260 in the execution. In some embodiments, the performance evaluator 340 may determine the runtime performance score by aggregating one or more scores. The one or more scores may indicate one or more of the execution speeds of the computing device 260, memory misses, utilization of memories, and so on. A score may have a weight. The runtime performance score may be a weighted aggregation (e.g., weighted sum or average) of the scores. The performance evaluator 340 may also compare the runtime performance score with the predicted performance score for the schedule. In embodiments where a difference between the runtime performance score and the predicted performance score is beyond a threshold, the performance evaluator 340 may request for further training of the trained model (e.g., the performance predictor 620) and can provide the runtime performance score and the schedule to a training module (e.g., the training module 630) to further train the trained model.

In some embodiments (such as embodiments where the schedule engine 310 generates a schedule tree based on memory misses predicted by a trained model), the performance evaluator 340 may also determine a runtime miss score indicating the runtime memory misses in the execution. In some embodiments, the performance evaluator 340 may determine the runtime miss score by aggregating one or more memory miss scores. A memory miss score may indicate misses of a memory associated with the computing device 260. The schedule engine 310 may assign different weights to different memories (e.g., the weight for L1 cache may be higher than the weight for L2 cache) and determine a weighted aggregation (e.g., weighted sum or average) of the memory miss scores. The performance evaluator 340 may also compare the runtime miss score with the predicted miss score for the schedule. In embodiments where a difference between the runtime miss score and the predicted miss score is beyond a threshold, the performance evaluator 340 may request for further training of the trained model and can provide the runtime miss score and the schedule to a training module (e.g., the training module 570) to further train the trained model.

The schedule update module 350 may change the schedule selected by the schedule engine 310 for the IR to a different schedule. In some embodiments (such as embodiments where the trained model is further trained), the schedule update module 350 may use the further trained model to select a different schedule from the schedule tree. The schedule update module 350 may also request the implementation module 320 to use the different schedule to transform the loop nest and to generate a different implementation. The computing device 260 may use a different implementation to execute tensor operations in future tensor computation. The re-selection by the schedule update module 350 may be beneficial, especially for inference workloads that repeat for a large number of times. It is worthwhile choosing and implementing a better schedule, if the current schedule is no longer predicted as the best. Over time, the IR can be optimized with better and better efficiency.

FIG. 4 is a block diagram of the schedule engine 310, in accordance with various embodiments. The schedule engine 310 can search optimal schedules for tensor operations in a deep learning model and further search an optimal schedule, from the optimal schedules for the tensor operations, for the deep learning model. The schedule engine 310 includes an operation parameter module 410, a hardware parameter module 420, a schedule generating module 430, and a schedule search module 440. In other embodiments, alternative configurations, different or additional components may be included in the schedule engine 310. Further, functionality attributed to a component of the schedule engine 310 may be accomplished by a different component included in the schedule engine 310 or by a different system.

The operation parameter module 410 identifies tensor operations in a deep learning model. In some embodiments, the operation parameter module 410 may identify one or more key operations in the deep learning model. The operation parameter module 410 may determine whether to select a tensor operation or not based on one or more factors, such as the amount of time needed for executing the tensor operation, the amount of computing resources needed for executing the tensor operation, the size of the tensor operation (e.g., the number of internal parameters for the tensor operation), spatial size of the input or output tensor (e.g., height or width of the input or output tensor), the number of input or output channels, spatial size of a kernel or filter, other attributes of the tensor operation, or some combination thereof.

The operation parameter module 410 also obtains one or more parameters of the identified tensor operations. In some embodiments, the one or more parameters may include the number of batches, spatial size of the input or output tensor (e.g., height or width of the input or output tensor), the number of input or output channels, spatial size of a kernel or filter, strides of scanning the input features, padding of the input features, data type of the input or output tensor, other parameters, or some combination thereof. In some embodiments, the operation parameter module 410 may obtain the same parameter(s) for different tensor operations. In other embodiments, the operation parameter module 410 may obtain different parameters for different tensor operations.

The hardware parameter module 420 obtains parameters of hardware executing the deep learning model. The hardware may include one or more processors, one or more memories, or other types of computing components. In some embodiments, the hardware includes one or more computing devices, such as the computing device 260. Example hardware parameters (e.g., parameters of a processor) may include the number of cores per socket, the number of threads per core, configuration of the caches (e.g., total size, line size, associativity, etc.), parameters of FMAs (floating-point multiply-add units) (e.g., the number of FMAs per core, the latency of an FMA pipeline, etc.), the number of floating-point vector registers per core, the width of a vector register, other parameters, or some combination thereof.

The schedule generating module 430 generates schedules trees for tensor operations in the deep learning model, e.g., the identified tensor operations. In some embodiments, the schedule generating module 430 may generate a schedule tree for each respective tensor operation. The schedule generating module 430 includes a search module 450, a schedule generator 460, and a schedule datastore 470. The search module 450 searches for schedules that can be used for a target IR in a schedule datastore 470. An example of the target IR is the IR 225 in FIG. 2. The schedule datastore 470 stores a plurality of IR categories. An IR category is a category of IRs including the same tensor operation and the same tensor reference. But loop extents in the IRs of the same category may be different. Each IR category in the schedule datastore 470 corresponds to one or more schedule trees, which are also stored in the schedule datastore 470. A schedule tree for an IR category may be a schedule tree that has been used (or has been proved to be valid) to optimize an IR in the IR category.

The search module 450 determines whether the target IR falls into any of the IR categories in the schedule datastore 470. For instance, the search module 450 determines the tensor operation and tensor references in the target IR. The search module 450 then determines whether the tensor operation and tensor references in the target IR match the tensor operation and tensor references in any of the IR categories. The search module 450 determines that the target IR falls into an IR category in response to determining that the tensor operation in the target IR matches the tensor operation and tensor references in the IR category.

Further, the search module 450 retrieves the schedule trees of the IR category and generate a schedule tree for the target IR based on the retrieved schedule trees. In some embodiments, the search module 450 uses all the retrieved schedule trees as candidate schedule trees of the target IR. In other embodiments, the search module 450 uses a subset of the retrieved schedule trees as candidate schedule trees of the target IR. For instance, the search module 450 may determine a similarity score that indicates an extent of similarity between the target IR and the IR of a retrieved schedule tree, e.g., based on a comparison of one or more loop extents in the target IR with one or more corresponding loop extents in the IR. In response to determining that the similarity score is below a threshold similarity score or below similarity scores of some or all the other retrieved schedule trees, the search module 450 may remove the schedule tree and use the other retrieved schedule trees as candidate schedule trees of the target IR.

In some embodiments (e.g., embodiments where the search module 450 obtains multiple candidate schedule trees for the target IR), the search module 450 merges the candidate schedule trees to a merged schedule tree of the target IR. The search module 450 may make the target IR as the root of the merged schedule tree and make each candidate schedule tree a branch of the root. The target IR and each candidate schedule tree has a parent-child relationship. Within an individual candidate schedule tree that includes multiple schedules, these schedules may have parent-child relationship or sibling relationship. The search module 450 may assign different priorities to the candidate schedule trees based on the similarity scores of the candidate schedule trees. A candidate schedule tree having a higher similarity score (i.e., the IR of the candidate schedule tree is more similar to the target IR) can have a higher priority in the merged schedule tree.

After the candidate schedule trees are merged, the search module 450 may modify or remove incompatible schedules in the merged schedule tree. For instance, the search module 450 may identify a schedule for loop tiling and determine whether the tiling factors of the schedule is compatible with the target IR, e.g., by determining whether the result of dividing the loop sizes in the target IR with the tiling factors are integers. The search module 450 may identify the schedule based on a determination that IR of the schedule is not the same as the target IR, e.g., the loop sizes of the IR are different from the loop sizes of the target IR. In response to determine that the tiling factors of the schedule are incompatible with the target IR (e.g., some results of the division are not integers), the search module 450 may remove the schedule from the merged schedule tree.

Alternatively, the search module 450 may modify one or more loops that are incompatible with the schedule. For instance, the search module 450 adjusts the tiling factor of an incompatible loop to make the loop tiling compatible with the loop, e.g., to make the result of dividing the loop extent by the tiling factor an integer. In some embodiments such as embodiments where the loop tiling schedule is incompatible with multiple loops, the search module 450 may modify multiple loops in the loop nest. The search module 450 may start with the innermost loop. The innermost tiled loop may be a loop corresponding to the highest memory hierarchy, e.g., registers. The search module 450 may determine a suitable loop extent for the innermost tiled loop under consideration, such that the register-level microkernel(s) performance can be kept the best. Next, the search module 450 may determine a suitable extent for a L1 cache tiled loop under consideration, such that the L1 cache misses are minimized, and so on. The modification process might use the heatmap and cache miss predictors described below. After the incompatible schedule(s) (if any) is modified or removed, the search module 450 can output the schedule tree of the target IR.

In embodiments where the search module 450 determines that the target IR does not fall into any of the IR categories in the schedule datastore 470, the search module 450 may request the schedule generator 460 to generate a schedule tree for the target IR from scratch. The schedule generator 460 may generate the schedule tree starting with loop tiling. For instance, the schedule generator 460 partitions a loop nest in the target IR into multiple memory loop nests for all the memories associated with the computing device 260. Each memory loop nest corresponds to a different memory. For a memory loop nest, the schedule generator 460 may determine one or more permutations for changing the order of the loops in the memory loop nest and determine extents of the loops. Then the schedule generator 460 can generate a schedule tree based on the permutations and loop extents.

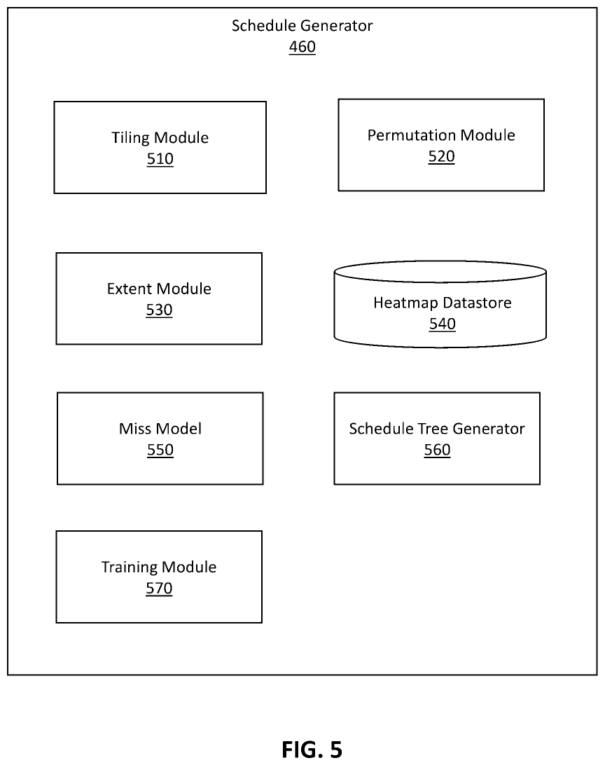

After the schedule generator 460 generates the schedule tree for the target IR, the schedule generator 460 can also create a new IR category and store the new IR category and the schedule tree in the schedule datastore 470. The IR category has the same tensor operations and tensor references as the target IR. However, different from the target IR having a loop extent of a specific number, the corresponding loop extent of the IR category is a range that includes the specific number. For instance, a loop extent in the target IR is 16, but the IR category covers IRs having loop extents in the range from 1 to 64. More details regarding the schedule generator 460 are described below in conjunction with FIG. 5.

The schedule search module 440 search, from the schedules generated by the schedule generating module 430, an optimal schedule for the deep learning model. In some embodiments, the schedule search module 440 may select one or more schedules from the schedule tree for each identified tensor operation. For instance, the schedule selecting module may select the one or more schedules from the lowest level of the schedule tree. The schedule search module 440 may input each respective schedule at the lowest level into a trained model. The trained module can predict the performance of the hardware executing the tensor operation if the IR of the tensor operation is transformed using the schedule. The schedule search module 440 may input other data into the trained model, such as one or more parameters of the tensor operation obtained by the operation parameter module 410, one or more parameters of hardware that are obtained by the hardware parameter module 420, or some combination thereof. The trained model may output ranking of the schedules. The schedules may be ranked based on the predicted performance of the computing device executing the tensor operation (or the deep learning model) if the IR of the tensor operation is transformed based on each respective schedule. In some embodiments, the trained model may be specific to the hardware or the type of hardware that executes the deep learning model. For instance, the trained model may be specific to the type of processing unit executing the deep learning model. The schedule search module 440 may train or use different models to predict performance of different types of hardware. The schedule search module 440 may select one or more schedules that are ranked higher (i.e., with better predicted performance) than one or more other schedules at the lowest level. The schedule search module 440 may use the trained model to select schedules for all the identified tensor operations.

The schedule search module 440 search, from the selected schedules for the identified tensor operation, a combined schedule for the deep learning model. The combined schedule includes a schedule for each respective tensor operation. In some embodiments, the schedule search module 440 may generate a graph including a plurality of levels. Each level corresponds to a different tensor operation and includes the one or more schedules selected for the tensor operation. A tensor operation represented by a level may be a producing tensor operation, and a tensor operation represented by the immediately subsequent level may be a consuming tensor operation. Data computed by the producing tensor operation may be input of the consuming tensor operation. The schedule search module 440 may build edges between every two adjacent levels, where each respective schedule for the producing tensor operation is connected to each respective schedule for the consuming tensor operation. The edges constitute a plurality of paths, each path is from a schedule in the first level to a schedule in the last level and includes a schedule in each respective level.

The schedule search module 440 may determine a weight for each respective edge. The weight may be a data transformation score indicating computing resources needed or required for transforming an output tensor of the producing tensor operation optimized with the first schedule to an input tensor of the consuming tensor operation optimized with the second schedule. The schedule search module 440 may further determine a total data transformation score for each respective path. The schedule search module 440 may use the total data transformation scores of the paths to select a path, such as a path having the lowest total data transformation score. The schedules along the selected path constitute the combined schedule for the deep learning model. Certain aspects of the schedule search module 440 are described below in conjunction with FIG. 6.

FIG. 5 is a block diagram of the schedule generator 460, in accordance with various embodiments. As described above, the schedule generator 460 generates a schedule tree for a target IR. The schedule generator 460 includes a tiling module 510, a permutation module 520, an extent module 530, a heatmap datastore 540, a miss model 550, a schedule tree generator 560, and a training module 570. In other embodiments, alternative configurations, different or additional components may be included in the schedule generator 460. Further, functionality attributed to a component of the schedule generator 460 may be accomplished by a different component included in the schedule generator 460 or by a different system.

The tiling module 510 identifies a loop nest in the target IR and partitions the loop nest into multiple loop nests through loop tiling. In some embodiments, the tiling module 510 may tile each loop in the loop nest into separate loops based on memory levels associated with the computing device 260. The memory levels may include registers, L1 cache, L2 cache . . . , and the last level cache. Each of the separate loops corresponds to a different memory level. For instance, a loop is split to a register loop, a L1 cache loop, a L2 cache loop, . . . , and a last level cache loop. After the loop tiling, there will be multiple loop nests, each of which corresponds to a different memory level and has N memory loops.

In an example, the loop nest includes n loops: 11, 12, . . . in, where n is an integer that is larger than 2. The computing device 260 is associated with four memory levels: registers, L1 cache, L2 cache, L3 cache, and main storage (e.g., DRAM (dynamic random-access memory)), where the L3 cache is the last level cache. The tiling module 510 splits each of the n loops into five memory loops, each of which corresponds to one of the five memory levels. As a result, the tiling module 510 generates five memory loop nests. The first memory loop nest is for the registers and includes n loops: i_{1Register}, i_{2Register}, . . . i_{nRegister}. The second memory loop nest is for the L1 cache and includes n loops: i_{1L1}, i_{2L1}, . . . i_{nL1}. The third memory loop nest is for the L2 cache and includes n loops: i_{1L2}, i_{2L2}, . . . i_{nL2}. The fourth memory loop nest is for the L3 cache and includes n loops: i_{1L3}, i_{2L3}, . . . i_{nL3}. The fifth memory loop nest is for the main memory and includes n loops: i_{1Mem}, i_{2Mem}, . . . i_{nMem}. The loops i_{1Register}, i_{1L1}, i_{1L2}, i_{1L3}, and i_{1Mem} are generated by partitioning the loop i₁. Similarly, the loops i_{2Register}, i_{2L1}, i_{2L2}, i_{2L3}, and i_{2Mem} are generated by partitioning the loop i₂, and the loops i_{nRegister}, o_{nL1}, i_{nL2}, i_{nL3}, and i_{nMem} are generated by partitioning the loop iₙ.

The permutation module 520 adjusts orders of the memory loops in one or more memory loop nests. For a particular memory level, the permutation module 520 determines one or more loop permutations and uses the determined one or more loop permutations to change the order of the memory loops in the corresponding memory loop nest to minimize data movement to and from the memory. The permutation module 520 may generate the one or more loop permutations by using an analytical model technique. In some embodiments, the permutation module 520 does not adjust the orders of all the memory loop nests. For instance, the permutation module 520 may determine not to adjust the order of the register loops in the register loop nest. The register loops are at the innermost level, and these loops and the loop body must match one or more microkernels. The permutation module 520 may determine that the order of the register loops does not need to be adjusted because the register loops will be replaced by the microkernels anyway.

The extent module 530 determines one or more sets of loop extents for each memory loop nest. The extent module 530 may process the memory loop nests in an order determined based on the hierarchies of the memories, e.g., from the memory having the highest hierarchy to the memory having the lowest hierarchy. For instance, the extent module 530 may first determine loop extents for the registers, then determines loop extents for L1 cache, followed by L2 cache, all the way to the last level cache. In some embodiments, the extent module 530 determines an optimal set of loop extents for the register loop nest. For instance, for a brgemm (batch-reduced general matrix multiply) microkernel in TPP (Tensor Processing Primitives), a loop extent set (bc, bk)=(32, 24) could yield an optimal performance, where bc and bk are the loop extents of two register loops. The optimal set of loop extents can yield an optical performance of the computing device 260, e.g., by enabling full utilization (or near-full utilization) of the registers. In some embodiments, the extent module 530 may maintain a heatmap stored in the heatmap datastore 540. The heatmap represents a relationship between various loop extent sets and the corresponding performances. The extent module 530 may identify an optimal set for the register loops from the heatmap.

In other embodiments, the extent module 530 may determine one or more sets of loop extents (“loop extent sets”) for a memory loop nest based on predicted misses of the corresponding memory. Each loop extent set includes loop extents for all the memory loops in the memory loop nest and corresponds to a different loop permutation determined by the permutation module 520. The loop extent set can minimize the misses of the memory if the memory loop nest is reordered based on the loop permutation. Taking a cache loop nest for example, the extent module 530 may determine one or more optimal loop extent sets for each loop permutation that the permutation module 520 has determined for the cache loop nest.

To determine optimal loop extent sets for a loop permutation of a memory loop nest, the extent module 530 may obtain a plurality of candidate loop extent sets. The candidate loop extent sets may be generated based on the original loop extents of the memory loops. The extent module 530 then uses the miss model 550 to determine whether a candidate loop extent set is an optimal loop extent set. For instance, the extent module 530 inputs the loop extents in the candidate loop extent set into the miss model 550. The extent module 530 may also input other attributes associated with the memory loop nest into the miss model 550. The attributes may include, for example, loop extents of inner loops, tensor references, data reuse factor, tensor operation, and so on. A data reuse factor indicates the extent to which data can be reused in a loop and can be determined through a data reuse analysis. The miss model 550 outputs a miss score that indicates a number of predicted misses of the memory. The extent module 530 can rank the candidate loop extent sets based on their miss scores and select one or more candidate loop extent sets as the optimal loop extent set(s) based on the ranking. For instance, the extent module 530 may select candidate loop extent sets having miss scores below a threshold score or lower than miss scores of the other candidate loop extent sets.

After the permutation module 520 determines the loop permutations and the extent module 530 determines the loop extents, the schedule tree generator 560 generates a schedule tree for the target IR. The schedule tree starts with a root that includes the target IR. The root is the first level of the schedule tree. The root has a couple of children as nodes in the second level of the target IR. Every node in the second level can be one permutation of the tiled loops with one loop extent set. A node may have one or more children spawned as new nodes. The schedule tree generator 560 may remove unit loops, i.e., loops whose extents equal 1. Additionally or alternatively, the schedule tree generator 560 may collapse adjacent parallel loops into a single parallel loop. Parallel loops are loops that can be executed in parallel, as opposed to being executed sequentially.

The training module 570 trains the miss model 550. The training module 570 applies machine learning techniques to generate the miss model 550 that when applied to attributes of a memory loop nest outputs a miss score indicating predicted memory misses. As part of the generation of the miss model 550, the training module 570 may form a training set. A training set includes training samples and ground-truth labels of the training samples. A training sample may include a set of attributes of a memory loop nest. The training sample may have a ground-truth miss score, the miss score may be a known miss score or a miss score that has been verified. The training module 570 extracts feature values from the training set, the features being variables deemed potentially relevant to memory misses. An ordered list of the features may be a feature vector. In one embodiment, the training module 570 applies dimensionality reduction (e.g., via linear discriminant analysis (LDA), principle component analysis (PCA), or the like) to reduce the amount of data in the feature vectors to a smaller, more representative set of data.

The training module 570 may use supervised machine learning to train the miss model 550, e.g., with the feature vectors of the positive training set and the negative training set serving as the inputs. Different machine learning techniques—such as linear support vector machine (linear SVM), boosting for other algorithms (e.g., AdaBoost), neutral networks, logistic regression, naïve Bayes, memory-based learning, random forests, bagged trees, decision trees, boosted trees, or boosted stumps—may be used in different embodiments.

In some embodiments, a validation set is formed of data associated with additional memory loop nests, other than those in the training sets, which have known or verified miss scores. The training module 570 applies the trained miss model 550 to the memory loop nests of the validation set to quantify the accuracy of the miss model 550. The accuracy may be determined based on differences between miss scores determined by the miss model 550 and the known or verified miss scores. In one embodiment, the training module 570 iteratively re-trains the miss model 550 until the occurrence of a stopping condition, such as the accuracy measurement indication that the model is sufficiently accurate, or a number of training rounds having taken place.

In some embodiments, the training module 570 continuously trains a part of or the whole miss model 550. For instance, after the training module 570 trains the miss model 550, the miss model 550 receives attributes of a memory loop nest and outputs a miss score. The training module 570 may receive performance information after the computing device 260 executes the tensor computation based on the memory loop nest. The training module 570 can determine a runtime miss score based on the performance information. The runtime miss score indicates the real memory misses during the execution of the tensor computation. The training module 570 uses the memory loop nest and the run time miss score as a new training sample to further train the miss model 550. The training module 570 can continuously generate new training sets and re-train the miss model 550 as it receives more performance information and determines more runtime miss scores.

FIG. 6 is a block diagram of the schedule search module 440, in accordance with various embodiments. The schedule search module 440 includes an operation schedule selector 610, a performance predictor 620, a training module 630, a graph module 640, and a model schedule selector 650. In other embodiments, alternative configurations, different or additional components may be included in the schedule search module 440. Further, functionality attributed to a component of the schedule search module 440 may be accomplished by a different component included in the schedule search module 440 or by a different system.

The operation schedule selector 610 selects schedules for tensor operations. In some embodiments, the operation schedule selector 610 selects one or more schedules from the schedule tree for a target IR. The target IR may be for a particular tensor operation. The schedule is to be used to transform the loop nest in the target IR, such as a tensor operation identified by the operation parameter module 410. In some embodiments, the operation schedule selector 610 evaluates the schedule(s) based on predicted performances of the computing device 260 executing the tensor computation using the schedules in the schedule tree (e.g., the schedules in the lowest hierarchy level of the schedule tree). For instance, the operation schedule selector 610 determines a performance score for a schedule. The performance score indicates a predicted performance of the computing device 260 executing the tensor computation using the schedule. The operation schedule selector 610 can rank the schedules based on the performance scores and select one or more schedules having the highest or higher ranking, e.g., the schedules that can trigger the best or relatively better performance of the computing device 260.

The operation schedule selector 610 can determine performance scores by using the performance predictor 620. The performance predictor 620 is a model that has been trained to receive one or more attributes of IRs after being transformed with schedules and outputs performance scores for the schedules. The attributes include loop extents, tensor references, tensor operations, other attributes, or some combination thereof. The operation schedule selector 610 can input one or more attributes of the IR 225 after being transformed by each respective schedule in the schedule tree. The operation schedule selector 610 then receives a performance score for each respective schedule from the performance predictor 620.

The training module 630 trains the performance predictor 620. In some embodiments, the training module 630 may train the performance predictor 620 based on one or more parameters of the hardware executing the deep learning model. The training module 630 may train multiple performance predictors for different types of computing devices that can be used to execute deep learning models. For instance, the training module 630 may train different performance predictors for different types of processing units. In an example, the training module 630 may train a performance predictor for CPU (central processing unit), another one for GPU (graphics processing unit), yet another one for VPU (vision processing unit), and so on. In another example, the training module 630 may train different performance predictors for processing units with different parameters, even though the processing units may be of the same type.

The training module 630 applies machine learning techniques to generate the performance predictor 620 that when applied to attributes of an IR being transformed with a schedule outputs a performance score indicating a predicted performance of the computing device 260 executing tensor computation based on the IR. As part of the generation of the performance predictor 620, the training module 630 may form a training set. A training set includes training samples and ground-truth labels of the training samples. A training sample may include one or more attributes of an IR being transformed with a schedule. The training sample may have a ground-truth performance score, the performance score may be a known performance score or a performance score that has been verified. The training module 630 extracts feature values from the training set, the features being variables deemed potentially relevant to memory misses. An ordered list of the features may be a feature vector. In one embodiment, the training module 630 applies dimensionality reduction (e.g., via LDA, PCA, or the like) to reduce the amount of data in the feature vectors to a smaller, more representative set of data.

The training module 630 may use supervised machine learning to train the performance predictor 620, e.g., with the feature vectors of the training set. Different machine learning techniques—such as linear support vector machine (linear SVM), boosting for other algorithms (e.g., AdaBoost), neutral networks, logistic regression, naïve Bayes, memory-based learning, random forests, bagged trees, decision trees, boosted trees, or boosted stumps—may be used in different embodiments.

In some embodiments, a validation set is formed of data associated with additional IRs and additional schedules, other than those in the training sets, which have known or verified performance scores. The training module 630 applies the trained performance predictor 620 to the additional IRs and schedules of the validation set to quantify the accuracy of the performance predictor 620. The accuracy may be determined based on differences between performance scores determined by the performance predictor 620 and the known or verified performance scores. In one embodiment, the training module 630 iteratively re-trains the performance predictor 620 until the occurrence of a stopping condition, such as the accuracy measurement indication that the model is sufficiently accurate, or a number of training rounds having taken place.

In some embodiments, the training module 630 continuously trains a part of or the whole performance predictor 620. For instance, after the training module 630 trains the performance predictor 620, the performance predictor 620 receives attributes of a memory loop nest and outputs a performance score. The training module 630 may receive performance information after the computing device 260 executes the tensor computation based on the memory loop nest. The training module 630 can determine a runtime performance score based on the performance information. The runtime performance score indicates the real memory misses during the execution of the tensor computation. The training module 630 uses the memory loop nest and the run time performance score as a new training sample to further train the performance predictor 620. The training module 630 can continuously generate new training sets and re-train the performance predictor 620 as it receives more performance information and determines more runtime performance scores.

The graph module 640 generates a graph with schedules selected by the operation schedule selector 610 for tensor operations in the deep learning model. The graph module 640 may generate a level for each respective tensor operation. A level includes the one or more schedules that the operation schedule selector 610 selected for the corresponding tensor operation. In some embodiments, the levels are arranged in a sequence. The sequence of the levels may follow the sequence of the tensor operations in the deep learning model. For instance, for a first level and a second level that are arranged next to each other with the second level immediately subsequent to the first level, the first level is for a tensor operation in a layer in the deep learning model, while the second level is for a tensor operation in a subsequent layer in the deep learning model. The output data of the tensor operation corresponding to the first level may be used as input of the tensor operation corresponding to the second level. The tensor operation corresponding to the first level may be the producing tensor operation, and the tensor operation corresponding to the second level may be the consuming tensor operation.

The graph module 640 also generates edges between the levels. Each edge connects a schedule in a level to a schedule in the immediately subsequent level. In some embodiments, each respective schedule in the level is connected to each respective schedule in the immediately subsequent level. In an embodiment where the level has N schedule(s) and the immediately subsequent level has M schedule(s), and N and M are integers equal to or greater than one, the number of edges between the two levels may equal N times M. The edges in the graph may constitute a plurality of paths. In some embodiments, each path starts with a schedule in the first level in the graph and ends with a schedule in the last level of the graph.

Each path may be a combined schedule that includes a schedule from each of the levels in the graph. The combined schedule may be used for loop transformation for the deep learning model.

The model schedule selector 650 searches a schedule for the deep learning model. For instance, the model schedule selector 650 may solve a dynamic programming problem based on the graph generated by the graph module 640 to search an optimal schedule for the deep learning model. The model schedule selector 650 determines weights for paths in the graph generated by the graph module 640. In some embodiments, the model schedule selector 650 determines a weight for each of the edges in the graph. The weight of an edge may be a data transformation score that indicates the amount of computing resources needed or required to transform the layout of data elements in an output tensor of the producing tensor operation to a desirable layout of data elements in an input tensor of the consuming tensor operation, if the IRs of the producing tensor operation and the consuming tensor operation are respectively transformed using the two schedules connected by the edge. Different schedules include different loop transformations, which can result in different data layouts of the tensor. Edges that start (or end) with the same schedule can have different weights as they end (or start) with different schedules.

The model schedule selector 650 may aggregate the weights of the edges in a path to compute a total weight of the path. In some embodiments, the model schedule selector 650 may accumulate the weights of the edges to compute the total weight of the path. In other embodiments, the model schedule selector 650 may assign scale factors to the edges, scale the edges based on the scale factors (e.g., by multiplying each respective edge with its scale factor), and accumulate the scaled weights to compute the total weight of the path. The scale factor of an edge may be determined based on one or more parameters of one or both tensor operations corresponding to the edge. The model schedule selector 650 may select the path that requires the lowest computing resources for data transformation, e.g., the lowest total weight. The combined schedule corresponding to the path will be used to transform the IRs of the tensor operations in the deep learning model. A schedule in the combined schedule will be used to transform the IR of the corresponding tensor operation.

### Example Graph

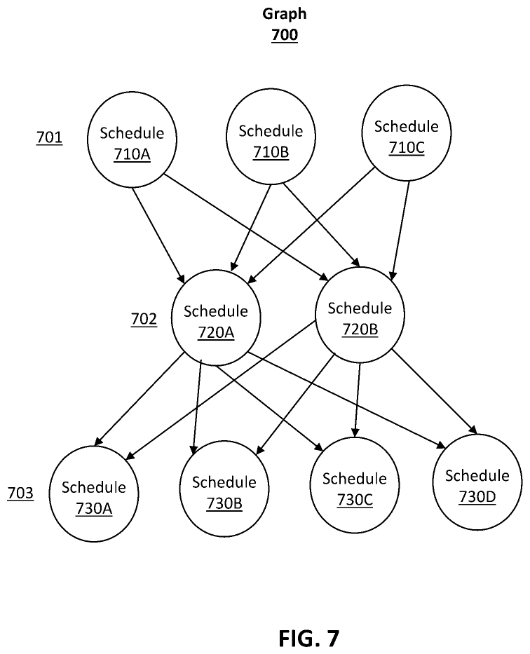

FIG. 7 illustrates an example graph 700 for searching a schedule for a deep learning model, in accordance with various embodiments. The graph 700 may be generated by the graph module 640 in FIG. 6. For the purpose of illustration, the graph 700 includes three levels 701, 702, and 703. The level 701 includes three schedules 710A-710C (collectively referred to as “schedules 710” or “schedule 710”). The level 702 includes two schedules 720A and 720B (collectively referred to as “schedules 720” or “schedule 720”). The level 703 includes four schedules 730A-730D (collectively referred to as “schedules 730” or “schedule 730”). In other embodiments, the graph 700 may include a different number of levels, and a level may include a different number of schedules.

The level 701 corresponds to a first tensor operation in the deep learning model. The level 702 corresponds to a second tensor operation in the deep learning model. The level 703 corresponds to a third tensor operation in the deep learning model. The three tensor operations may be in a sequence in the deep learning model. For instance, the second tensor operation may be in a layer of the deep learning model that is subsequent to a layer including the first tensor operation, and the third tensor operation may be in a layer of the deep learning model that is subsequent to a layer including the second tensor operation. In some embodiments, at least one of the three tensor operations may be in multiple layers of the deep learning model. The output data of the first tensor operation may be used as input of the second tensor operation. The output data of the second tensor operation may be used as input of the third tensor operation. The three tensor operations may be identified by the operation parameter module 410 in FIG. 1, e.g., as key tensor operations of the deep learning model.

The schedules in each level may be selected by the operation schedule selector 610 in FIG. 6, e.g., by using the performance predictor 620. The graph 700 includes edges between the levels. An edge is represented by an arrow in FIG. 7. There are six edges between the level 701 and the level 702. Each of the six edges connects a schedule 710 to a schedule 720. There are eight edges between the level 702 and the level 703, each of the eight edges connects a schedule 720 to a schedule 730. The fourteen edges constitute 48 paths. Each of the 48 paths corresponds to a combined schedule that includes a schedule 710, a schedule 720, and a schedule 730. The graph 700 may be used, e.g., by the model schedule selector 650, to search for an optimal path for the deep learning model. The three schedules in the optimal path may be used to transform the IRs of the three tensor operations, respectively.

### Example Schedule Tree

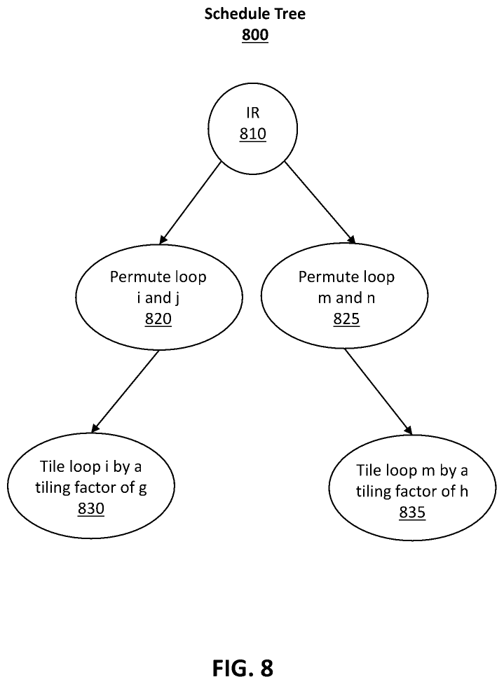

FIG. 8 illustrates an example schedule tree 800, in accordance with various embodiments. The schedule tree 800 may be generated by the schedule generating module 430 in FIG. 4. As shown in FIG. 8, the schedule tree 800 includes an IR 810 and four schedules 820, 825, 830, and 835. The IR 810 is the root of the schedule tree 800. The four schedules 820, 825, 830, and 835 are the nodes of the schedule tree 800, in which the schedules 820 and 825 are children of the root, versus the schedules 830 and 835 are grandchildren of the root. The schedules 820 and 830 constitute a first branch of the schedule tree 800. The schedules 825 and 835 constitute a second branch of the schedule tree 800. The IR 810 is the first level of the schedule tree 800. The schedules 820 and 825 are the second level. The schedules 830 and 835 are the third level.

The schedule 820 specifies a permutation of loops i and j, i.e., a change in the order of the loops i and j. The schedule 830, which is the child of the schedule 820, specifies tiling loop i by a tiling factor of g. For instance, the schedule 830 can split loop i into 2 loops: an outer loop and an inner loop. The extent of the outer loop may equal the original extent of loop i divided by g, and the extent of the inner loop may equal g. Alternatively, the extent of the inner loop may equal the original extent of loop i divided by g, and the extent of the outer loop may equal g. The schedule 830, as the child of the schedule 820, incorporates the schedule 820. In embodiments where the schedule 830 is selected for implementation, the loops i and j will be first permuted in accordance with the information in the schedule 820, then loop i will be split in accordance with the information in the schedule 830.

The schedule 825, which is in parallel with the schedule 820 and is a sibling of the schedule 825, specifies a permutation of loops m and n, i.e., a change in the order of the loops m and n. The schedule 835, which is the child of the schedule 825, specifies tiling loop m by a tiling factor h. For instance, the schedule 835 can split loop m into 2 loops: an outer loop and an inner loop. The extent of the outer loop may equal the original extent of loop m divided by h, and the extent of the inner loop may equal h. Alternatively, the extent of the inner loop may equal the original extent of loop m divided by h, and the extent of the outer loop may equal h. The schedule 835, as the child of the schedule 825, incorporates the schedule 825. In embodiments where the schedule 835 is selected for implementation, the loops m and n will be first permuted in accordance with the information in the schedule 825, then loop m will be split in accordance with the information in the schedule 835.

For purpose of simplicity and illustration, the schedule tree 800 in FIG. 8 includes four schedules, two branches, and three levels. In other embodiments, the schedule tree 800 may include a different number of schedules, a different number of branches, a different number of levels, a different structure, or some combination thereof.

### Example Method of Generating Schedule for Deep Learning Model

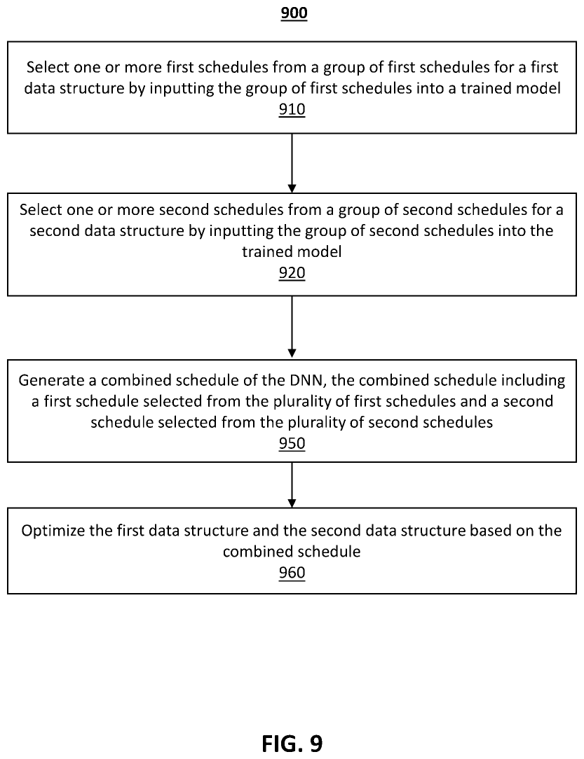

FIG. 9 is a flowchart showing a method 900 of generating a schedule for a deep learning model, in accordance with various embodiments. The method 900 may be performed by the deep learning compiler 230 in FIGS. 3 and 4. Although the method 900 is described with reference to the flowchart illustrated in FIG. 9, many other methods of generating schedules for deep learning models may alternatively be used. For example, the order of execution of the steps in FIG. 9 may be changed. As another example, some of the steps may be changed, eliminated, or combined.

The deep learning compiler 230 selects 910 one or more first schedules from a group of first schedules for a first data structure by inputting the group of first schedules into a trained model. The first data structure describes a first tensor operation in a deep learning model. Each first schedule specifies one or more loop transformations to be performed on the first data structure. The trained model outputs a selection of the one or more schedules. In some embodiments, the deep learning compiler 230 generates the group of first schedules based on one or more parameters of the first tensor operation, one or more parameters of a computing device executing the first tensor operation, or some combination thereof. In some embodiments, in addition to the group of first schedules, the deep learning compiler 230 inputs one or more parameters of a computing device executing the first tensor operation or one or more parameters of the first tensor operation into the trained model.

The deep learning compiler 230 selects 920 one or more second schedules from a group of second schedules for a second data structure by inputting the group of second schedules into the trained model. The second data structure describes a second tensor operation in a deep learning model. Each second schedule specifies one or more loop transformations to be performed on the second data structure. The trained model outputs a selection of the one or more schedules. In some embodiments, the deep learning compiler 230 generates the group of second schedules based on one or more parameters of the second tensor operation, one or more parameters of a computing device executing the second tensor operation, or some combination thereof. In some embodiments, in addition to the group of second schedules, the deep learning compiler 230 inputs one or more parameters of a computing device executing the second tensor operation or one or more parameters of the second tensor operation into the trained model.

In some embodiments, the deep learning compiler 230 receives information indicating a runtime performance of the computing device executing the deep learning model based on the combined schedule. The deep learning compiler 230 may update the trained model based on an evaluation of the runtime performance.

The deep learning compiler 230 generates 930 a combined schedule of the deep learning model. The combined schedule includes a first schedule selected from the one or more first schedules and a second schedule selected from the one or more second schedules. In some embodiments, the deep learning compiler 230 identifies a plurality of schedule sets. Each schedule set comprising a respective first schedule of the one or more first schedules and a respective second schedule of the one or more second schedules. For each schedule set, the deep learning compiler 230 determines a data transformation score that indicates computing resource required for transforming an output tensor of the first tensor operation optimized with the respective first schedule to an input tensor of the second tensor operation optimized with the respective second schedule. The deep learning compiler 230 selects a schedule set from the popularity of schedule sets based on data transformation scores of the plurality of schedule sets. In some embodiments, the output tensor of the first tensor operation comprises one or more data elements arranged in a first layout. The input tensor of the second tensor operation comprises one or more data elements arranged in a second layout. The deep learning compiler 230 transforms the output tensor to the input tensor by transforming the first layout to the second layout.

In some embodiments, the combined schedule further comprises a third schedule selected from one or more third schedules. Each third schedule specifies one or more transformations to be performed on a third data structure. The third data structure describes a third tensor operation in the deep learning model. In some embodiments, the deep learning compiler 230 identifies a plurality of schedule sets. Each schedule set comprises a respective first schedule of the one or more first schedules, a respective second schedule of the one or more second schedules, and a respective third schedule of the one or more third schedules. For each schedule set, the deep learning compiler 230 determines a first data transformation score that indicates computing resource required for transforming an output tensor of the first tensor operation optimized with the respective first schedule to an input tensor of the second tensor operation optimized with the respective second schedule. The deep learning compiler 230 determines a second data transformation score that indicates computing resource required for transforming an output tensor of the second tensor operation optimized with the respective second schedule to an input tensor of the third tensor operation optimized with the respective third schedule. The deep learning compiler 230 selects a schedule set from the popularity of schedule sets based on first data transformation scores and second transformation scores of the plurality of schedule sets.

The deep learning compiler 230 optimizes 940 the first data structure and the second data structure based on the combined schedule. For instance, the deep learning compiler 230 may transform the first data structure using the first schedule in the combined schedule. The deep learning compiler 230 may also transform the second data structure using the second schedule in the combined schedule.

### Example Deep Learning Environment

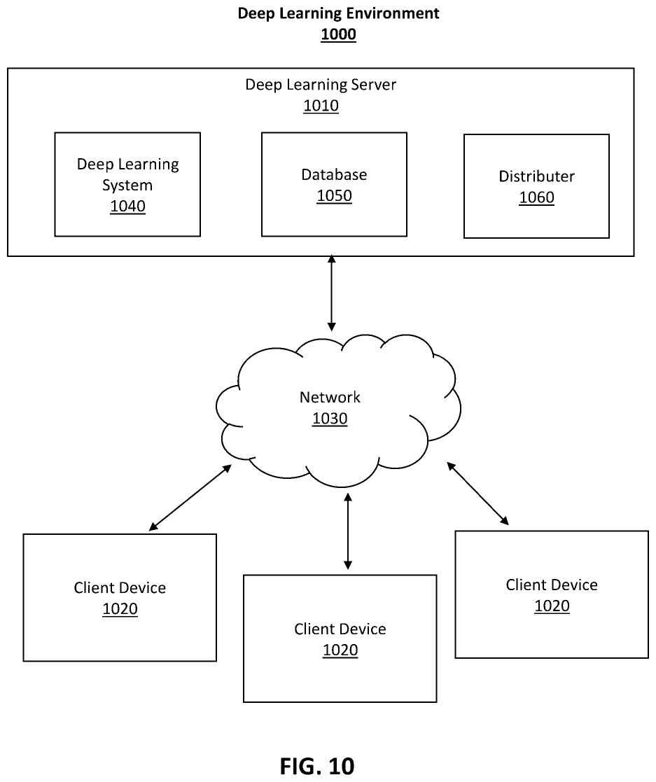

FIG. 10 illustrates a deep learning environment 1000, in accordance with various embodiments. The deep learning environment 1000 includes a deep learning server 1010 and a plurality of client devices 1020 (individually referred to as client device 1020). The deep learning server 1010 is connected to the client devices 1020 through a network 1030. In other embodiments, the deep learning environment 1000 may include fewer, more, or different components.

The deep learning server 1010 trains deep learning models using neural network architectures. A neural network is structured like the human brain and consists of artificial neurons, also known as nodes. These nodes are stacked next to each other in three types of layers: input layer, hidden layer(s), and output layer. Data provides each node with information in the form of inputs. The node multiplies the inputs with random weights, calculates them, and adds a bias. Finally, nonlinear functions, also known as activation functions, are applied to determine which neuron to fire. The deep learning server 1010 can use various types of deep learning models, such as CNN, recurrent neural network (RNN), generative adversarial network (GAN), long short-term memory network (LSTMN), and so on. During the process of training the DL models, the neural networks use unknown elements in the input distribution to extract features, group objects, and discover useful data patterns. The DL models can be used to solve various problems, e.g., making predictions, classifying images, and so on. The deep learning server 1010 may build DL models specific to particular types of problems that need to be solved. A DL model is trained to receive an input and output the solution to the particular problem.

In FIG. 10, the deep learning server 1010 includes a deep learning system 1040, a database 1050, and a distributer 1060. The deep learning system 1040 trains DNNs. The DNNs can be used to process images, e.g., images captured by autonomous vehicles, medical devices, satellites, and so on. In an embodiment, a DNN receives an input image and outputs classifications of objects in the input image. An example of the DNNs is the DNN 100 described above in conjunction with FIG. 1. In some embodiments, the deep learning system 1040 trains DNNs through knowledge distillation, e.g., dense-connection based knowledge distillation. The trained DNNs may be used on low memory systems, like mobile phones, IOT edge devices, and so on.

The database 1050 stores data received, used, generated, or otherwise associated with the deep learning server 1010. For example, the database 1050 stores a training dataset that the deep learning system 1040 uses to train DNNs. In an embodiment, the training dataset is an image gallery that can be used to train a DNN for classifying images. The training dataset may include data received from the client devices 1020. As another example, the database 1050 stores hyperparameters of the neural networks built by the deep learning server 1010.

The distributer 1060 distributes DL models generated by the deep learning server 1010 to the client devices 1020. In some embodiments, the distributer 1060 receives a request for a DNN from a client device 1020 through the network 1030. The request may include a description of a problem that the client device 1020 needs to solve. The request may also include information of the client device 1020, such as information describing available computing resource on the client device. The information describing available computing resource on the client device 1020 can be information indicating network bandwidth, information indicating available memory size, information indicating processing power of the client device 1020, and so on. In an embodiment, the distributer may instruct the deep learning system 1040 to generate a DNN in accordance with the request. The deep learning system 1040 may generate a DNN based on the information in the request. For instance, the deep learning system 1040 can determine the structure of the DNN and/or train the DNN in accordance with the request.

In another embodiment, the distributer 1060 may select the DNN from a group of pre-existing DNNs based on the request. The distributer 1060 may select a DNN for a particular client device 1020 based on the size of the DNN and available resources of the client device 1020. In embodiments where the distributer 1060 determines that the client device 1020 has limited memory or processing power, the distributer 1060 may select a compressed DNN for the client device 1020, as opposed to an uncompressed DNN that has a larger size. The distributer 1060 then transmits the DNN generated or selected for the client device 1020 to the client device 1020.

In some embodiments, the distributer 1060 may receive feedback from the client device 1020. For example, the distributer 1060 receives new training data from the client device 1020 and may send the new training data to the deep learning system 1040 for further training the DNN. As another example, the feedback includes an update of the available computer resource on the client device 1020. The distributer 1060 may send a different DNN to the client device 1020 based on the update. For instance, after receiving the feedback indicating that the computing resources of the client device 1020 have been reduced, the distributer 1060 sends a DNN of a smaller size to the client device 1020.

The client devices 1020 receive DNNs from the distributer 1060 and applies the DNNs to perform machine learning tasks, e.g., to solve problems or answer questions. In various embodiments, the client devices 1020 input images into the DNNs and uses the output of the DNNs for various applications, e.g., visual reconstruction, augmented reality, robot localization and navigation, medical diagnosis, weather prediction, and so on. A client device 1020 may be one or more computing devices capable of receiving user input as well as transmitting and/or receiving data via the network 1030. In one embodiment, a client device 1020 is a conventional computer system, such as a desktop or a laptop computer. Alternatively, a client device 1020 may be a device having computer functionality, such as a personal digital assistant (PDA), a mobile telephone, a smartphone, an autonomous vehicle, or another suitable device. A client device 1020 is configured to communicate via the network 1030. In one embodiment, a client device 1020 executes an application allowing a user of the client device 1020 to interact with the deep learning server 1010 (e.g., the distributer 1060 of the deep learning server 1010). The client device 1020 may request DNNs or send feedback to the distributer 1060 through the application. For example, a client device 1020 executes a browser application to enable interaction between the client device 1020 and the deep learning server 1010 via the network 1030. In another embodiment, a client device 1020 interacts with the deep learning server 1010 through an application programming interface (API) running on a native operating system of the client device 1020, such as IOS® or ANDROID™.

In an embodiment, a client device 1020 is an integrated computing device that operates as a standalone network-enabled device. For example, the client device 1020 includes display, speakers, microphone, camera, and input device. In another embodiment, a client device 1020 is a computing device for coupling to an external media device such as a television or other external display and/or audio output system. In this embodiment, the client device 1020 may couple to the external media device via a wireless interface or wired interface (e.g., an HDMI (High-Definition Multimedia Interface) cable) and may utilize various functions of the external media device such as its display, speakers, microphone, camera, and input devices. Here, the client device 1020 may be configured to be compatible with a generic external media device that does not have specialized software, firmware, or hardware specifically for interacting with the client device 1020.

The network 1030 supports communications between the deep learning server 1010 and client devices 1020. The network 1030 may comprise any combination of local area and/or wide area networks, using both wired and/or wireless communication systems. In one embodiment, the network 1030 may use standard communications technologies and/or protocols. For example, the network 1030 may include communication links using technologies such as Ethernet, 10010.11, worldwide interoperability for microwave access (WiMAX), 3G, 4G, code division multiple access (CDMA), digital subscriber line (DSL), etc. Examples of networking protocols used for communicating via the network 1030 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 1030 may be represented using any suitable format, such as hypertext markup language (HTML) or extensible markup language (XML). In some embodiments, all or some of the communication links of the network 1030 may be encrypted using any suitable technique or techniques.

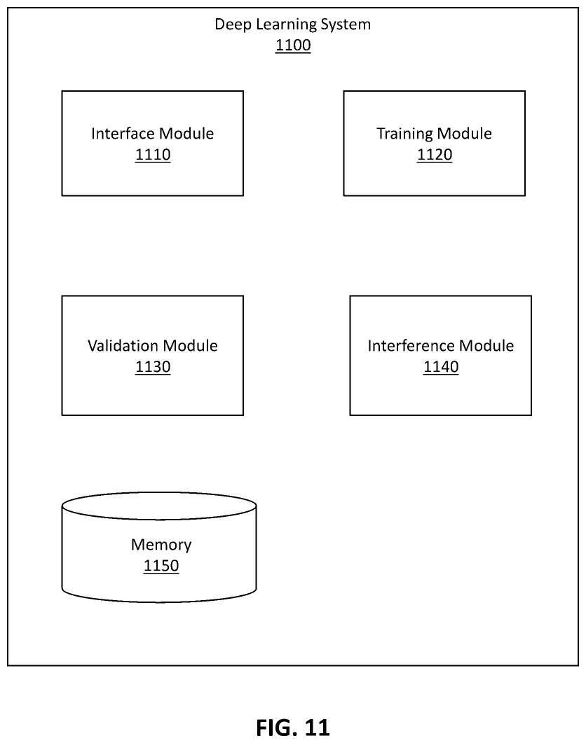

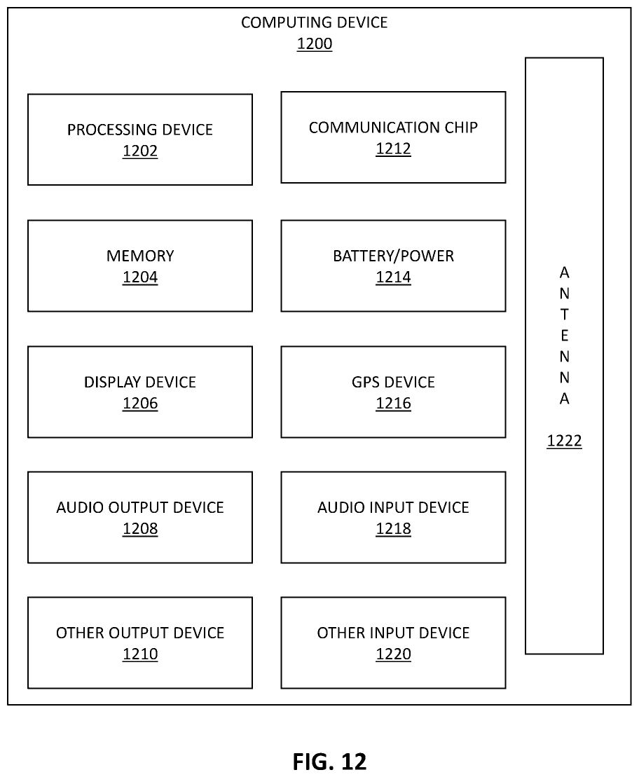

FIG. 11 is a block diagram of an example deep learning system 1100, in accordance with various embodiments. The whole deep learning system 1100 or a part of the deep learning system 1100 may be implemented in the computing device 1200. The deep learning system 1100 trains DNNs for various tasks, such as image classification, learning relationships between biological cells (e.g., DNA, proteins, etc.), control behaviors for devices (e.g., robots, machines, etc.), and so on. The deep learning system 1100 includes an interface module 1110, a training module 1120, a validation module 1130, an inference module 1140, and a memory 1150. In other embodiments, alternative configurations, different or additional components may be included in the deep learning system 1100. Further, functionality attributed to a component of the deep learning system 1100 may be accomplished by a different component included in the deep learning system 1100 or a different system. The deep learning system 1100 or a component of the deep learning system 1100 (e.g., the training module 1120 or inference module 1140) may include the computing device 1200 in FIG. 12.

The interface module 1110 facilitates communications of the deep learning system 1100 with other systems. For example, the interface module 1110 establishes communications between the deep learning system 1100 with an external database to receive data that can be used to train DNNs or input into DNNs to perform tasks. As another example, the interface module 1110 supports the deep learning system 1100 to distribute DNNs to other systems, e.g., computing devices configured to apply DNNs to perform tasks.

The training module 1120 trains DNNs by using a training dataset. The training module 1120 forms the training dataset. In an embodiment where the training module 1120 trains an DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the validation module 1130 to validate performance of a trained DNN. The portion of the training dataset not including the tuning subset and the validation subset may be used to train the DNN.

The training module 1120 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 11, 110, 500, 1100, or even larger.

The training module 1120 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include three channels). A pooling layer is used to reduce the spatial volume of input image after convolution. It is used between two convolution layers. A fully connected layer involves weights, biases, and neurons. It connects neurons in one layer to neurons in another layer. It is used to classify images between different category by training.

In the process of defining the architecture of the DNN, the training module 1120 also adds an activation function to a hidden layer or the output layer. An activation function of a layer transforms the weighted sum of the input of the layer to an output of the layer. The activation function may be, for example, a ReLU activation function, a tangent activation function, or other types of activation functions.

After the training module 1120 defines the architecture of the DNN, the training module 1120 inputs a training dataset into the DNN. The training dataset includes a plurality of training samples. An example of a training sample includes an object in an image and a ground-truth label of the object. The training module 1120 modifies the parameters inside the DNN (“internal parameters of the DNN”) to minimize the error between labels of the training objects that are generated by the DNN and the ground-truth labels of the objects. The internal parameters include weights of filters in the convolutional layers of the DNN. In some embodiments, the training module 1120 uses a cost function to minimize the error.

The training module 1120 may train the DNN for a predetermined number of epochs. The number of epochs is a hyperparameter that defines the number of times that the DL algorithm will work through the entire training dataset. One epoch means that each sample in the training dataset has had an opportunity to update internal parameters of the DNN. After the training module 1120 finishes the predetermined number of epochs, the training module 1120 may stop updating the parameters in the DNN. The DNN having the updated parameters is referred to as a trained DNN.

The validation module 1130 verifies accuracy of trained DNNs. In some embodiments, the validation module 1130 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 1130 determines may determine an accuracy score measuring the precision, recall, or a combination of precision and recall of the DNN. The validation module 1130 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 1130 may compare the accuracy score with a threshold score. In an example where the validation module 1130 determines that the accuracy score of the augmented model is lower than the threshold score, the validation module 1130 instructs the training module 1120 to re-train the DNN. In one embodiment, the training module 1120 may iteratively re-train the DNN until the occurrence of a stopping condition, such as the accuracy measurement indication that the DNN may be sufficiently accurate, or a number of training rounds having taken place.

The inference module 1140 applies the trained or validated DNN to perform tasks. For instance, the inference module 1140 inputs images into the DNN. The DNN outputs classifications of objects in the images. As an example, the DNN may be provisioned in a security setting to detect malicious or hazardous objects in images captured by security cameras. As another example, the DNN may be provisioned to detect objects (e.g., road signs, hazards, humans, pets, etc.) in images captured by cameras of an autonomous vehicle. The input to the DNN may be formatted according to a predefined input structure mirroring the way that the training dataset was provided to the DNN. The DNN may generate an output structure which may be, for example, a classification of the image, a listing of detected objects, a boundary of detected objects, or the like. In some embodiments, the inference module 1140 distributes the DNN to other systems, e.g., computing devices in communication with the deep learning system 1100, for the other systems to apply the DNN to perform the tasks.

The memory 1150 stores data received, generated, used, or otherwise associated with the deep learning system 1100. For example, the memory 1150 stores the datasets used by the training module 1120 and validation module 1130. The memory 1150 may also store data generated by the training module 1120 and validation module 1130, such as the hyperparameters for training DNNs, internal parameters of trained DNNs (e.g., values of tunable parameters of FALUs), etc. In the embodiment of FIG. 11, the memory 1150 is a component of the deep learning system 1100. In other embodiments, the memory 1150 may be external to the deep learning system 1100 and communicate with the deep learning system 1100 through a network.

### Example Computing Device

FIG. 12 is a block diagram of an example computing device 1200, in accordance with various embodiments. In some embodiments, the computing device 1200 can be used as the deep learning system 1100 in FIG. 11. A number of components are illustrated in FIG. 12 as included in the computing device 1200, but any one or more of these components may be omitted or duplicated, as suitable for the application. In some embodiments, some or all of the components included in the computing device 1200 may be attached to one or more motherboards. In some embodiments, some or all of these components are fabricated onto a single system on a chip (SoC) die. Additionally, in various embodiments, the computing device 1200 may not include one or more of the components illustrated in FIG. 12, but the computing device 1200 may include interface circuitry for coupling to the one or more components. For example, the computing device 1200 may not include a display device 1206, but may include display device interface circuitry (e.g., a connector and driver circuitry) to which a display device 1206 may be coupled. In another set of examples, the computing device 1200 may not include an audio input device 1218 or an audio output device 1208, but may include audio input or output device interface circuitry (e.g., connectors and supporting circuitry) to which an audio input device 1218 or audio output device 1208 may be coupled.

The computing device 1200 may include a processing device 1202 (e.g., one or more processing devices). The processing device 1202 processes electronic data from registers and/or memory to transform that electronic data into other electronic data that may be stored in registers and/or memory. An embodiment of the processing device 1202 may be the computing device 260 in FIG. 2. The computing device 1200 may include a memory 1204, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1204 may include memory that shares a die with the processing device 1202. In some embodiments, the memory 1204 includes one or more non-transitory computer-readable media storing instructions executable to perform operations for deep learning, e.g., the method 900 described above in conjunction with FIG. 9 or the operations performed by the deep learning compiler 230 described above in conjunction with FIGS. 2-6. The instructions stored in the one or more non-transitory computer-readable media may be executed by the processing device 2402.

In some embodiments, the computing device 1200 may include a communication chip 1212 (e.g., one or more communication chips). For example, the communication chip 1212 may be configured for managing wireless communications for the transfer of data to and from the computing device 1200. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1212 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP 2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1212 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1212 may operate in accordance with other wireless protocols in other embodiments. The computing device 1200 may include an antenna 1222 to facilitate wireless communications and/or to receive other wireless communications (such as AM or FM radio transmissions).

In some embodiments, the communication chip 1212 may manage wired communications, such as electrical, optical, or any other suitable communication protocols (e.g., the Ethernet). As noted above, the communication chip 1212 may include multiple communication chips. For instance, a first communication chip 1212 may be dedicated to shorter-range wireless communications such as Wi-Fi or Bluetooth, and a second communication chip 1212 may be dedicated to longer-range wireless communications such as global positioning system (GPS), EDGE, GPRS, CDMA, WiMAX, LTE, EV-DO, or others. In some embodiments, a first communication chip 1212 may be dedicated to wireless communications, and a second communication chip 1212 may be dedicated to wired communications.

The computing device 1200 may include battery/power circuitry 1214. The battery/power circuitry 1214 may include one or more energy storage devices (e.g., batteries or capacitors) and/or circuitry for coupling components of the computing device 1200 to an energy source separate from the computing device 1200 (e.g., AC line power).

The computing device 1200 may include a display device 1206 (or corresponding interface circuitry, as discussed above). The display device 1206 may include any visual indicators, such as a heads-up display, a computer monitor, a projector, a touchscreen display, a liquid crystal display (LCD), a light-emitting diode display, or a flat panel display, for example.

The computing device 1200 may include an audio output device 1208 (or corresponding interface circuitry, as discussed above). The audio output device 1208 may include any device that generates an audible indicator, such as speakers, headsets, or earbuds, for example.

The computing device 1200 may include an audio input device 1218 (or corresponding interface circuitry, as discussed above). The audio input device 1218 may include any device that generates a signal representative of a sound, such as microphones, microphone arrays, or digital instruments (e.g., instruments having a musical instrument digital interface (MIDI) output).

The computing device 1200 may include a GPS device 1216 (or corresponding interface circuitry, as discussed above). The GPS device 1216 may be in communication with a satellite-based system and may receive a location of the computing device 1200, as known in the art.

The computing device 1200 may include an other output device 1210 (or corresponding interface circuitry, as discussed above). Examples of the other output device 1210 may include an audio codec, a video codec, a printer, a wired or wireless transmitter for providing information to other devices, or an additional storage device.

The computing device 1200 may include an other input device 1220 (or corresponding interface circuitry, as discussed above). Examples of the other input device 1220 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (register fileID) reader.

The computing device 1200 may have any desired form factor, such as a handheld or mobile computer system (e.g., a cell phone, a smart phone, a mobile internet device, a music player, a tablet computer, a laptop computer, a netbook computer, an ultrabook computer, a PDA, an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1200 may be any other electronic device that processes data.

### Select Examples

Example 1 provides a method for deep learning, the method including selecting one or more first schedules from a group of first schedules for a first data structure by inputting the group of first schedules into a trained model, the first data structure describing a first tensor operation in a deep learning model, each first schedule specifying one or more loop transformations to be performed on the first data structure, the trained model outputting a selection of the one or more schedules; selecting one or more second schedules from a group of second schedules for a second data structure by inputting the group of second schedules into the trained model, the second data structure describing a second tensor operation in the deep learning model, each second schedule specifying one or more loop transformations to be performed on the second data structure, the trained model outputting a selection of the one or more schedules; generating a combined schedule of the deep learning model, the combined schedule including a first schedule selected from the one or more first schedules and a second schedule selected from the one or more second schedules; and optimizing the first data structure and the second data structure based on the combined schedule.

Example 2 provides the method of example 1, further including generating the group of first schedules based on one or more parameters of the first tensor operation.

Example 3 provides the method of example 1 or 2, further including generating the group of first schedules based on one or more parameters of a computing device executing the first tensor operation.

Example 4 provides the method of any one of examples 1-3, where inputting the group of first schedules into the trained model includes inputting the group of first schedules and one or more parameters of a computing device executing the first tensor operation into the trained model.

Example 5 provides the method of example 4, further including receiving information indicating a runtime performance of the computing device executing the deep learning model based on the combined schedule; and updating the trained model based on an evaluation of the runtime performance.

Example 6 provides the method of any one of examples 1-5, where inputting the group of first schedules into the trained model includes inputting the group of first schedules and one or more parameters of the first tensor operation into the trained model.

Example 7 provides the method of any one of examples 1-6, where generating the combined schedule includes identifying a plurality of schedule sets, each schedule set including a respective first schedule of the one or more first schedules and a respective second schedule of the one or more second schedules; for each schedule set, determining a data transformation score that indicates computing resource required for transforming an output tensor of the first tensor operation optimized with the respective first schedule to an input tensor of the second tensor operation optimized with the respective second schedule; and selecting a schedule set from the popularity of schedule sets based on data transformation scores of the plurality of schedule sets.

Example 8 provides the method of example 7, where the output tensor of the first tensor operation includes one or more data elements arranged in a first layout, the input tensor of the second tensor operation includes one or more data elements arranged in a second layout, and transforming the output tensor to the input tensor including transforming the first layout to the second layout.

Example 9 provides the method of any one of examples 1-8, where the combined schedule further includes a third schedule selected from one or more third schedules, each third schedule specifies one or more transformations to be performed on a third data structure, the third data structure describes a third tensor operation in the deep learning model.

Example 10 provides the method of example 9, where generating the combined schedule includes identifying a plurality of schedule sets, each schedule set including a respective first schedule of the one or more first schedules, a respective second schedule of the one or more second schedules, and a respective third schedule of the one or more third schedules; for each schedule set, determining a first data transformation score that indicates computing resource required for transforming an output tensor of the first tensor operation optimized with the respective first schedule to an input tensor of the second tensor operation optimized with the respective second schedule, and determining a second data transformation score that indicates computing resource required for transforming an output tensor of the second tensor operation optimized with the respective second schedule to an input tensor of the third tensor operation optimized with the respective third schedule; and selecting a schedule set from the popularity of schedule sets based on first data transformation scores and second transformation scores of the plurality of schedule sets.

Example 11 provides one or more non-transitory computer-readable media storing instructions executable to perform operations for deep learning, the operations including selecting one or more first schedules from a group of first schedules for a first data structure by inputting the group of first schedules into a trained model, the first data structure describing a first tensor operation in a deep learning model, each first schedule specifying one or more loop transformations to be performed on the first data structure, the trained model outputting a selection of the one or more schedules; selecting one or more second schedules from a group of second schedules for a second data structure by inputting the group of second schedules into the trained model, the second data structure describing a second tensor operation in the deep learning model, each second schedule specifying one or more loop transformations to be performed on the second data structure, the trained model outputting a selection of the one or more schedules; generating a combined schedule of the deep learning model, the combined schedule including a first schedule selected from the one or more first schedules and a second schedule selected from the one or more second schedules; and optimizing the first data structure and the second data structure based on the combined schedule.

Example 12 provides the one or more non-transitory computer-readable media of example 11, where the operations further include generating the group of first schedules based on one or more parameters of the first tensor operation or one or more parameters of a computing device executing the first tensor operation.

Example 13 provides the one or more non-transitory computer-readable media of example 11 or 12, where inputting the group of first schedules into the trained model includes inputting the group of first schedules and one or more parameters of a computing device executing the first tensor operation or one or more parameters of the first tensor operation into the trained model.

Example 14 provides the one or more non-transitory computer-readable media of any one of examples 11-13, where generating the combined schedule includes identifying a plurality of schedule sets, each schedule set including a respective first schedule of the one or more first schedules and a respective second schedule of the one or more second schedules; for each schedule set, determining a data transformation score that indicates computing resource required for transforming an output tensor of the first tensor operation optimized with the respective first schedule to an input tensor of the second tensor operation optimized with the respective second schedule; and selecting a schedule set from the popularity of schedule sets based on data transformation scores of the plurality of schedule sets.

Example 15 provides the one or more non-transitory computer-readable media of any one of examples 11-14, where the combined schedule further includes a third schedule selected from one or more third schedules, each third schedule specifies one or more transformations to be performed on a third data structure, the third data structure describes a third tensor operation in the deep learning model.

Example 16 provides an apparatus for deep learning, the apparatus including a computer processor for executing computer program instructions; and a non-transitory computer-readable memory storing computer program instructions executable by the computer processor to perform operations including selecting one or more first schedules from a group of first schedules for a first data structure by inputting the group of first schedules into a trained model, the first data structure describing a first tensor operation in a deep learning model, each first schedule specifying one or more loop transformations to be performed on the first data structure, the trained model outputting a selection of the one or more schedules, selecting one or more second schedules from a group of second schedules for a second data structure by inputting the group of second schedules into the trained model, the second data structure describing a second tensor operation in the deep learning model, each second schedule specifying one or more loop transformations to be performed on the second data structure, the trained model outputting a selection of the one or more schedules, generating a combined schedule of the deep learning model, the combined schedule including a first schedule selected from the one or more first schedules and a second schedule selected from the one or more second schedules, and optimizing the first data structure and the second data structure based on the combined schedule.

Example 17 provides the apparatus of example 16, where the operations further include generating the group of first schedules based on one or more parameters of the first tensor operation or one or more parameters of a computing device executing the first tensor operation.

Example 18 provides the apparatus of example 16 or 17, where inputting the group of first schedules into the trained model includes inputting the group of first schedules and one or more parameters of a computing device executing the first tensor operation or one or more parameters of the first tensor operation into the trained model.

Example 19 provides the apparatus of any one of examples 16-18, where generating the combined schedule includes identifying a plurality of schedule sets, each schedule set including a respective first schedule of the one or more first schedules and a respective second schedule of the one or more second schedules; for each schedule set, determining a data transformation score that indicates computing resource required for transforming an output tensor of the first tensor operation optimized with the respective first schedule to an input tensor of the second tensor operation optimized with the respective second schedule; and selecting a schedule set from the popularity of schedule sets based on data transformation scores of the plurality of schedule sets.

Example 20 provides the apparatus of any one of examples 16-19, where the combined schedule further includes a third schedule selected from one or more third schedules, each third schedule specifies one or more transformations to be performed on a third data structure, the third data structure describes a third tensor operation in the deep learning model.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method for deep learning, the method comprising:
selecting one or more first schedules from a group of first schedules for a first data structure by inputting the group of first schedules into a trained model, the first data structure describing a first tensor operation in a deep learning model, each first schedule specifying one or more loop transformations to be performed on the first data structure, the trained model outputting a selection of the one or more schedules;
selecting one or more second schedules from a group of second schedules for a second data structure by inputting the group of second schedules into the trained model, the second data structure describing a second tensor operation in the deep learning model, each second schedule specifying one or more loop transformations to be performed on the second data structure, the trained model outputting a selection of the one or more schedules;
generating a combined schedule of the deep learning model, the combined schedule including a first schedule selected from the one or more first schedules and a second schedule selected from the one or more second schedules; and
optimizing the first data structure and the second data structure based on the combined schedule.

2. The method of claim 1, wherein generating the group of first schedules for the first data structure comprises:
generating the group of first schedules based on one or more parameters of the first tensor operation.

3. The method of claim 2, wherein generating the group of first schedules for the first data structure further comprises:
generating the group of first schedules based on one or more parameters of a computing device executing the first tensor operation.

4. The method of claim 1, wherein inputting the group of first schedules into the trained model comprises:
inputting the group of first schedules and one or more parameters of a computing device executing the first tensor operation into the trained model.

5. The method of claim 4, further comprising:
receiving information indicating a runtime performance of the computing device executing the deep learning model based on the combined schedule; and
updating the trained model based on an evaluation of the runtime performance.

6. The method of claim 1, wherein inputting the group of first schedules into the trained model comprises:
inputting the group of first schedules and one or more parameters of the first tensor operation into the trained model.

7. The method of claim 1, wherein generating the combined schedule comprises:
identifying a plurality of schedule sets, each schedule set comprising a respective first schedule of the one or more first schedules and a respective second schedule of the one or more second schedules;
for each schedule set, determining a data transformation score that indicates computing resource required for transforming an output tensor of the first tensor operation optimized with the respective first schedule to an input tensor of the second tensor operation optimized with the respective second schedule; and
selecting a schedule set from the popularity of schedule sets based on data transformation scores of the plurality of schedule sets.

8. The method of claim 7, wherein:
the output tensor of the first tensor operation comprises one or more data elements arranged in a first layout,
the input tensor of the second tensor operation comprises one or more data elements arranged in a second layout, and
transforming the output tensor to the input tensor comprising transforming the first layout to the second layout.

9. The method of claim 1, wherein the combined schedule further comprises a third schedule selected from one or more third schedules, each third schedule specifies one or more transformations to be performed on a third data structure, the third data structure describes a third tensor operation in the deep learning model.

10. The method of claim 9, wherein generating the combined schedule comprises:
identifying a plurality of schedule sets, each schedule set comprising a respective first schedule of the one or more first schedules, a respective second schedule of the one or more second schedules, and a respective third schedule of the one or more third schedules;
for each schedule set,
determining a first data transformation score that indicates computing resource required for transforming an output tensor of the first tensor operation optimized with the respective first schedule to an input tensor of the second tensor operation optimized with the respective second schedule, and
determining a second data transformation score that indicates computing resource required for transforming an output tensor of the second tensor operation optimized with the respective second schedule to an input tensor of the third tensor operation optimized with the respective third schedule; and
selecting a schedule set from the popularity of schedule sets based on first data transformation scores and second transformation scores of the plurality of schedule sets.

11. One or more non-transitory computer-readable media storing instructions executable to perform operations for deep learning, the operations comprising:
selecting one or more first schedules from a group of first schedules for a first data structure by inputting the group of first schedules into a trained model, the first data structure describing a first tensor operation in a deep learning model, each first schedule specifying one or more loop transformations to be performed on the first data structure, the trained model outputting a selection of the one or more schedules;
selecting one or more second schedules from a group of second schedules for a second data structure by inputting the group of second schedules into the trained model, the second data structure describing a second tensor operation in the deep learning model, each second schedule specifying one or more loop transformations to be performed on the second data structure, the trained model outputting a selection of the one or more schedules;
generating a combined schedule of the deep learning model, the combined schedule including a first schedule selected from the one or more first schedules and a second schedule selected from the one or more second schedules; and
optimizing the first data structure and the second data structure based on the combined schedule.

12. The one or more non-transitory computer-readable media of claim 11, wherein the operations further comprise:
generating the group of first schedules based on one or more parameters of the first tensor operation or one or more parameters of a computing device executing the first tensor operation.

13. The one or more non-transitory computer-readable media of claim 11, wherein inputting the group of first schedules into the trained model comprises:
inputting the group of first schedules and one or more parameters of a computing device executing the first tensor operation or one or more parameters of the first tensor operation into the trained model.

14. The one or more non-transitory computer-readable media of claim 11, wherein generating the combined schedule comprises:
identifying a plurality of schedule sets, each schedule set comprising a respective first schedule of the one or more first schedules and a respective second schedule of the one or more second schedules;
for each schedule set, determining a data transformation score that indicates computing resource required for transforming an output tensor of the first tensor operation optimized with the respective first schedule to an input tensor of the second tensor operation optimized with the respective second schedule; and
selecting a schedule set from the popularity of schedule sets based on data transformation scores of the plurality of schedule sets.

15. The one or more non-transitory computer-readable media of claim 11, wherein the combined schedule further comprises a third schedule selected from one or more third schedules, each third schedule specifies one or more transformations to be performed on a third data structure, the third data structure describes a third tensor operation in the deep learning model.

16. An apparatus for deep learning, the apparatus comprising:
a computer processor for executing computer program instructions; and
a non-transitory computer-readable memory storing computer program instructions executable by the computer processor to perform operations comprising:
selecting one or more first schedules from a group of first schedules for a first data structure by inputting the group of first schedules into a trained model, the first data structure describing a first tensor operation in a deep learning model, each first schedule specifying one or more loop transformations to be performed on the first data structure, the trained model outputting a selection of the one or more schedules,
selecting one or more second schedules from a group of second schedules for a second data structure by inputting the group of second schedules into the trained model, the second data structure describing a second tensor operation in the deep learning model, each second schedule specifying one or more loop transformations to be performed on the second data structure, the trained model outputting a selection of the one or more schedules,
generating a combined schedule of the deep learning model, the combined schedule including a first schedule selected from the one or more first schedules and a second schedule selected from the one or more second schedules; and
optimizing the first data structure and the second data structure based on the combined schedule.

17. The apparatus of claim 16, wherein the operations further comprise:
generating the group of first schedules based on one or more parameters of the first tensor operation or one or more parameters of a computing device executing the first tensor operation.

18. The apparatus of claim 16, wherein inputting the group of first schedules into the trained model comprises:
inputting the group of first schedules and one or more parameters of a computing device executing the first tensor operation or one or more parameters of the first tensor operation into the trained model.

19. The apparatus of claim 16, wherein generating the combined schedule comprises:
identifying a plurality of schedule sets, each schedule set comprising a respective first schedule of the one or more first schedules and a respective second schedule of the one or more second schedules;
for each schedule set, determining a data transformation score that indicates computing resource required for transforming an output tensor of the first tensor operation optimized with the respective first schedule to an input tensor of the second tensor operation optimized with the respective second schedule; and
selecting a schedule set from the popularity of schedule sets based on data transformation scores of the plurality of schedule sets.

20. The apparatus of claim 16, wherein the combined schedule further comprises a third schedule selected from one or more third schedules, each third schedule specifies one or more transformations to be performed on a third data structure, the third data structure describes a third tensor operation in the deep learning model.
